(19) United States
(12) Patent Application Publication
(10) Pub. No.: US 2019/0196763 A1
(43) Pub. Date: Jun. 27, 2019

(54) IMAGE PROCESSING APPARATUS AND PROGRAM

(71) Applicant: KONICA MINOLTA, INC., Tokyo (JP)

(72) Inventor: Hiroaki Kubo, Muko-shi (JP)

(73) Assignee: KONICA MINOLTA, INC., Tokyo (JP)

(21) Appl. No.: 16/218,927

(22) Filed: Dec. 13, 2018

(30) Foreign Application Priority Data
Dec. 25, 2017 (JP) 2017-248228

(51) Int. Cl. G06F 3/12; H04N 1/00; G06F 3/06

(52) U.S. Cl. CPC G06F 3/1237; H04N 1/00167; G06F 3/1295; G06F 3/0656; H04N 1/00482

(57) ABSTRACT

An image processing apparatus includes: a buffer memory; and a hardware processor that outputs an image, and executes detection processing for searching for a predetermined image pattern in the image output by the hardware processor, wherein the hardware processor arranges images of a plurality of jobs in a first direction and writes the images in the buffer memory, and advances the detection processing for the images of the plurality of jobs written in the buffer memory along a second direction intersecting with the first direction.

The entire disclosure of Japanese patent Application No. 2017-248228, filed on Dec. 25, 2017, is incorporated herein by reference in its entirety.

### BACKGROUND

### Technological Field

The present disclosure relates to an image processing apparatus and a program, and in particular, to an image processing apparatus that executes detection processing of searching for a predetermined image pattern in an output image, and a program executed by such an image processing apparatus.

### Description of the Related Art

Conventionally, there have been provided image processing apparatuses that execute detection processing for detecting whether an image to be output includes a predetermined image pattern. Various techniques have been proposed for shortening the time to output the image, for such image processing apparatuses.

For example, JP 2008-125029 A discloses an image processing apparatus that executes determination processing of generating image data for two surfaces by compressing an image in a sub-scanning direction and determining whether the image data for two surfaces is a specific document, and determines whether to prohibit an output of the image data on the basis of a result of the determination processing.

JP 2005-026880 A discloses an image forming apparatus. The image forming apparatus provides first color image data by reading an image on a first surface of a document, provides first normalized image data by normalizing the first color image data to image data in a predetermined color space, provides second color image data by reading an image on a second surface of the document, and provides second normalized image data by normalizing the second color image data to image data in a predetermined color space. The image forming apparatus stores a dictionary including image data of a specific document. The image forming apparatus aligns and joins the normalized color image data on both surfaces in a main scanning direction, and then determines whether the first and second normalized image data correspond to the image data of a specific document.

In recent years, an image processing apparatus such as a multi-functional peripheral (MFP) sometimes processes a plurality of jobs at the same time. Then, in such a case, shortening the time to output image data is required.

As a solution to such a problem, for example, there is a method of shortening the time required for detection processing by increasing the number of units for the detection processing in the image processing apparatus. However, this method is not appropriate because of an increase in cost and size of the image processing apparatus.

### SUMMARY

The present disclosure has been devised in view of the above circumstances, and an object of the present disclosure is to shorten the time required for detection processing for detecting a predetermined image pattern while avoiding an increase in cost and size in an image processing apparatus.

To achieve the abovementioned object, according to an aspect of the present invention, an image processing apparatus reflecting one aspect of the present invention comprises: a buffer memory; and a hardware processor that outputs an image, and executes detection processing for searching for a predetermined image pattern in the image output by the hardware processor, wherein the hardware processor arranges images of a plurality of jobs in a first direction and writes the images in the buffer memory, and advances the detection processing for the images of the plurality of jobs written in the buffer memory along a second direction intersecting with the first direction.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an appearance of an image processing apparatus according to the present disclosure;

FIG. 2 is a diagram illustrating a hardware configuration of the image processing apparatus in FIG. 1;

FIG. 3 is a diagram for describing functions implemented in an image processing apparatus;

FIG. 4 is a diagram schematically illustrating band division of an image in detection processing;

FIG. 5 is a diagram illustrating an example of writing an image to a buffer memory in a case where a CPU simultaneously executes the detection processing for a plurality of jobs;

FIG. 6 is a diagram illustrating an example of arrangement of execution units in the detection processing;

FIG. 7 is a diagram for describing an example in which a difference occurs in timing when images are written to the buffer memory among a plurality of jobs;

FIG. 8 is a diagram for describing detection processing in a comparative example;

FIG. 9 is a diagram for describing detection processing in a comparative example;

FIG. 10 is a diagram for describing the detection processing in the present embodiment and the comparative examples:

FIG. 11 is a diagram for describing the detection processing in the present embodiment and the comparative examples:

FIG. 12 is a diagram for describing the detection processing in the present embodiment and the comparative examples:

FIG. 13 is a diagram for describing the detection processing in the present embodiment and the comparative examples:

FIG. 14 is a diagram for describing the detection processing in the present embodiment and the comparative examples:

FIG. 15 is a diagram for describing the detection processing in the present embodiment and the comparative examples:

FIG. 16 is a diagram for describing the detection processing in the present embodiment and the comparative examples:

FIG. 17 is a diagram for describing the detection processing in the present embodiment and the comparative examples:

FIG. 18 is a diagram for describing the detection processing in the present embodiment and the comparative examples:

FIG. 19 is a diagram for describing the detection processing in the present embodiment and the comparative examples;

FIG. 20 is a flowchart of processing executed by the CPU to implement the detection processing in the image processing apparatus;

FIG. 21 is a flowchart of processing executed by the CPU to implement the detection processing in the image processing apparatus; and

FIG. 22 is a flowchart of processing executed by the CPU to implement the detection processing in the image processing apparatus.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same parts and constituent elements are denoted by the same reference numerals. Names and functions of the same parts and constituent elements are also the same. Therefore, description of the same parts and constituent elements will not be repeated.

[1. Basic Configuration of Image Processing Apparatus]

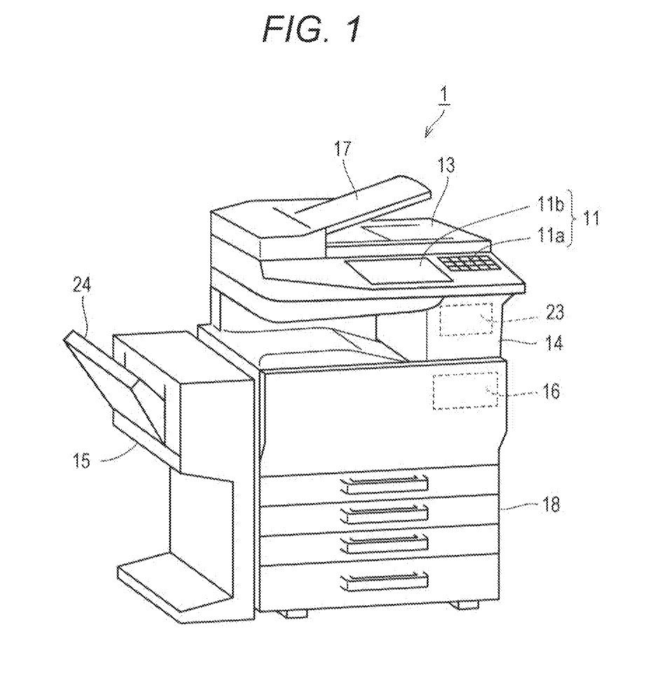

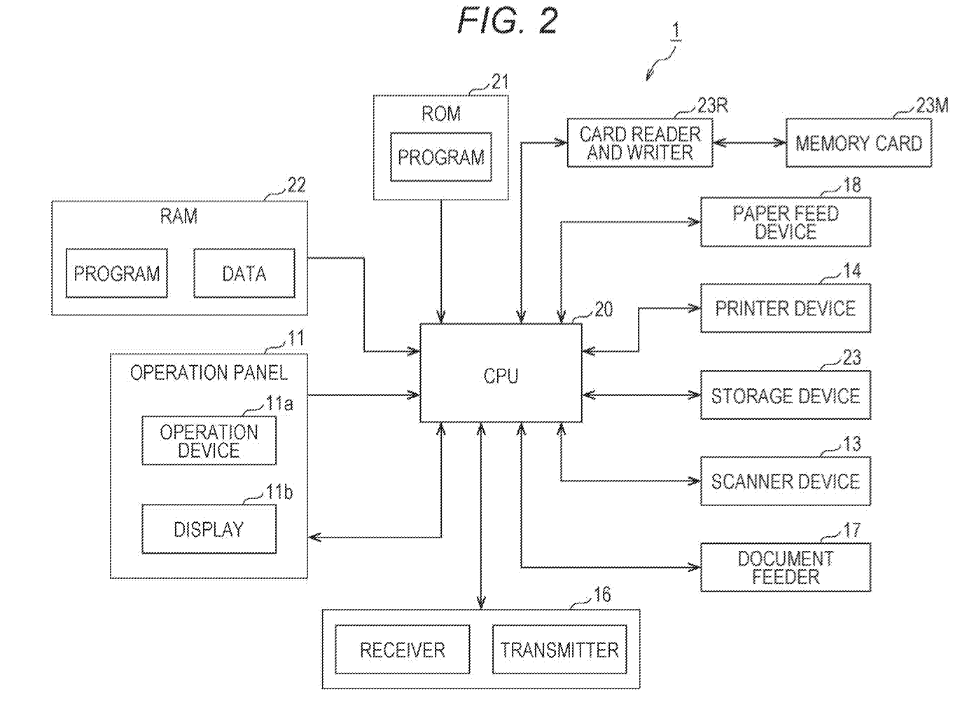

A basic configuration of an image processing apparatus 1 will be described with reference to FIGS. 1 and 2. FIG. 1 is a diagram illustrating an appearance of an image processing apparatus according to the present disclosure. FIG. 2 is a diagram illustrating a hardware configuration of the image processing apparatus in FIG. 1. An example of the image processing apparatus is a device in which functions of a multi-functional peripheral (MFP), that is, functions of copying, network printing, scanner, FAX communication (transmission and reception by facsimile communication), a document server, and the like are aggregated.

The image processing apparatus 1 includes an operation panel 11, a scanner device 13, a printer device 14, a finisher device 15 that performs processing such as stapling and punching, a communication interface 16, a document feeder 17, a paper feed device 18, a central processing unit (CPU) 20, a read only memory (ROM) 21, a random access memory (RAM) 22, a storage device 23, and a card reader and writer 23R.

The operation panel 11 includes an operation device 11a and a display 11b. The operation device 11a includes a plurality of keys for inputting numbers, letters, symbols, and the like, a sensor for recognizing various operated keys, and a transmission circuit for transmitting a signal indicating a recognized key to the CPU 20.

The display 11b displays a screen for giving a message or an instruction, a screen for a user to input setting content and processing content, a screen displaying an image formed by the image processing apparatus 1 and a result of processing, and the like. The display 11b may be a touch panel. In other words, at least part of the display 11b and the operation device 11a may be integrally configured. The display 11b has a function to detect a position on the touch panel touched by the user with a finger and transmit a signal indicating a detection result to the CPU 20.

The image processing apparatus 1 can communicate with an external device (for example, a personal computer (PC), a server, or the like) via the communication interface 16. An application program and a driver for giving commands to the image processing apparatus 1 may be installed in the external device. With the installation, the user can remotely operate the image processing apparatus 1 using the external device.

The scanner device 13 photoelectrically reads image information such as photographs, characters, pictures, and the like from a document to acquire image data. The acquired image data (density data) is converted into digital data by an image processor (not illustrated) and undergoes various types of known image processing, is then sent to the printer device 14 and the communication interface 16, and is provided for printing of the image or transmission of the data or is stored in the storage device 23 for later use. In the present embodiment, the scanner device 13 is configured to read images on both surfaces (front and back surfaces) of a document, but the scanner device of the image processing apparatus is not limited to such a device. The scanner device may be configured to read only an image on one surface of the document.

The printer device 14 prints image data acquired by the scanner device 13, image data received from the external device by the communication interface 16, or an image stored in the storage device 23, on a recording sheet such as a paper or a film. The paper feed device 18 is provided in a lower part of the main body of the image processing apparatus 1 and is used to supply a recording sheet suitable for an image to be printed to the printer device 14. The recording sheet on which an image has been printed by the printer device 14, that is, a printed material passes through the finisher device 15, is processed such as stapling or punching according to mode setting, and is discharged to a tray 24.

The communication interface 16 is a device including a transmitter and a receiver, for exchanging data with a PC and a FAX terminal. An example of the communication interface 16 is a network interface card (NIC), a modem, and/or a terminal adapter (TA).

The CPU 20 comprehensively controls the entire image processing apparatus 1 and implements basic functions such as a copy function, a print function, a scan function, and a facsimile function.

The ROM 21 is a memory for storing an operation program and the like of the CPU 20. The RAM 22 is a memory that provides a work area when the CPU 20 operates on the basis of the operation program. The CPU 20 loads the operation program from the ROM 21 or the like and loads various data, and performs work.

The storage device 23 is configured by a nonvolatile storage device such as a hard disk drive (HDD), and stores various applications, image data of a document read by the scanner device 13, and the like.

The card reader and writer 23R reads data from a memory card 23M such as compact flash (registered trademark), a universal serial bus (USB) memory, or smart media, or writes data to the memory card 23M. The memory card 23M is an example of a recording medium attachable to/detachable from the main body of the image processing apparatus 1, and is mainly used to exchange information with an external device without via a communication line or to back up data. The CPU 20 may implement the processing described in the present disclosure by executing the program stored in the memory card 23M.

[2. Functional Configuration of Image Processing Apparatus]

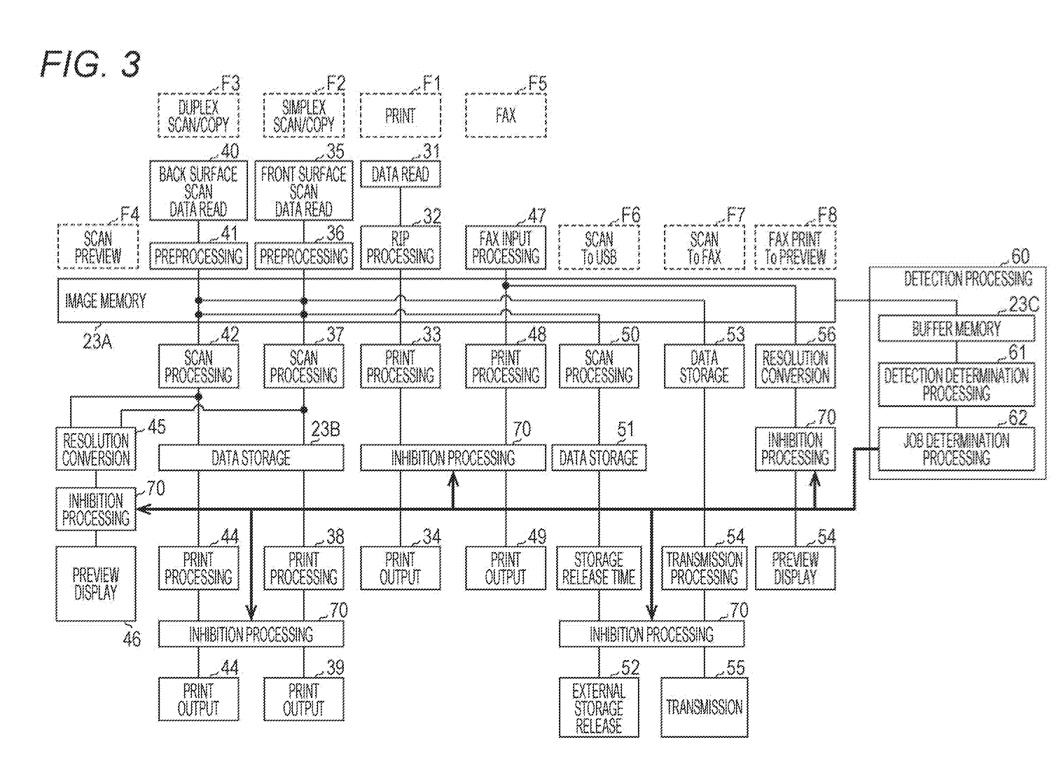

A functional configuration of the image processing apparatus 1 will be described with reference to FIG. 3. FIG. 3 is a diagram for describing functions implemented in the image processing apparatus 1. FIG. 3 illustrates functions F1 to F8 surrounded by broken lines. In the image processing apparatus 1, for example, these functions are implemented by the CPU 20 processing data. To implement these functions, an image memory 23A, a data storage 23B, and a buffer memory 23C are used. The image memory 23A, the data storage 23B, and the buffer memory 23C are configured by the storage device 23, for example. The functions are implemented by, for example, the CPU 20 executing a given program. Note that the functions may be shared and implemented by two or more processors. Two or more processors may constitute one apparatus (the image processing apparatus 1 or the like) or may be distributed in two or more apparatuses.

In the image processing apparatus 1, the CPU 20 executes detection processing 60 for detecting a specific image pattern in an image to be processed of the functions F1 to F8. The specific image pattern is a pattern that constitutes an image of which an output is prohibited, for example, an image of a bank bill. When detecting the specific image pattern in the image to be processed, the CPU 20 executes processing (inhibition processing 70) for inhibiting the output of the image with respect to the functions F1 to F8.

Hereinafter, operation of the image processing apparatus 1 for implementing the functions F1 to F8 will be described. Thereafter, the detection processing 60 and the inhibition processing 70 will be described.

<A. Operation of Image Processing Apparatus 1 for Functions F1 to F8>

(Function F1) Print

The print function outputs an image input from an external device by printing the image on a recording sheet. In the print function, the CPU 20 reads image data (job data) for printing by data read processing 31, and generates data in a raster format from data in a vector format included in the job data by raster image processor (RIP) processing 32. The CPU 20 writes RIP data generated by the RIP processing 32 to the image memory 23A.

In the present specification, “job” means individual operation unit such as printing, transmitting, receiving, or saving. An example of images of one job is images of all pages of a file of one-time print instruction. Another example is images of all pages received by one-time fax communication. Note that, in the present specification, in duplex scanning, images on front and back surfaces are treated as individual jobs. That is, in duplex scanning of a three-page document, images on front surfaces of three pages are treated as “images of one job” and images on back surfaces of three pages are treated as “images of another job”.

The CPU 20 executes print processing 33 such as conversion of the RIP data in the image memory 23A from an RGB system to a CMY system. Thereafter, the CPU 20 outputs the image corresponding to the image data after the print processing, using the printer device 14, by print output processing 34.

(Function F2) Simplex Scan/Copy

The simplex scan/copy function outputs an image on a front surface of a document read by the scanner device 13 by printing the image on the recording sheet. In the simplex scan/copy function, the CPU 20 reads image data on the front surface of the document from the scanner device 13 by front surface scan data read processing 35, and executes processing such as noise removal for the read data and conversion of the read data into RIP data by preprocessing 36. The CPU 20 writes the processed data to the image memory 23A.

After executing scan processing 37, the CPU 20 writes the RIP data in the image memory 23A to the data storage 23B. The CPU 20 executes print processing 38 such as conversion of the data written in the data storage 23B from the RGB system to the CMY system. Thereafter, the CPU 20 outputs the image corresponding to the data after the print processing, using the printer device 14, by print output processing 39.

(Function F3) Duplex Scan/Copy

The duplex scan/copy function outputs images on front and back surfaces of a document by printing the images on a recording sheet. In the duplex scan/copy function, the CPU 20 executes the following procedure in addition to the procedure in the simplex scan/copy function. That is, the CPU 20 reads image data on the back surface of the document from the scanner device 13 by back surface scan data read processing 40, and executes processing such as noise removal for the read data and conversion of the read data into RIP data by preprocessing 41. The CPU 20 writes the processed data to the image memory 23A.

After executing scan processing 42, the CPU 20 writes the RIP data in the image memory 23A to the data storage 23B. The CPU 20 executes print processing 43 such as conversion of the data written in the data storage 23B from the RGB system to the CMY system. Thereafter, the CPU 20 outputs the image corresponding to the data after the print processing, using the printer device 14, by print output processing 44.

(Function F4) Scan Preview

The scan preview function displays the image read by the scanner device 13 on the display 11b. In the scan preview function, the CPU 20 converts a resolution of the data after the scan processing 37 (simplex scan/copy function) into a display resolution by resolution conversion processing 45. In a case where the scanner device 13 has read the images on both surfaces, the CPU 20 further converts a resolution of the data after the scan processing 42 (duplex scan/copy function) into a display resolution by the resolution conversion processing 45. Thereafter, the CPU 20 displays the image of the data with the converted resolution on the display 11b by preview display processing 46.

(Function F5) FAX Function

The FAX function outputs an image of data received by the communication interface 16 by facsimile communication by printing the image on a recording sheet. In the FAX function, the CPU 20 generates RIP data from data received by facsimile communication by FAX input processing 47, and writes the RIP data to the image memory 23A.

The CPU 20 executes print processing 48 such as conversion of the RIP data in the image memory 23A from the RGB system to the CMY system. Thereafter, the CPU 20 outputs the image corresponding to the image data after the print processing, using the printer device 14, by print output processing 49.

(Function F6) Scan_To_USB

The scan_To_USB function writes data of an image read by the scanner device 13 to the memory card 23M such as a USB memory. In the scan_To_USB function, the CPU 20 executes scan processing 50 for the RIP data written in the image memory 23A after the preprocessing 36. The CPU 20 stores the data after the scan processing 50 to a transfer area to the memory card 23M in the storage device 23. Thereafter, the CPU 20 writes data of an image read by the scanner device 13 to the memory card 23M by external storage release processing 52. In a case where the scanner device 13 has read an image on a back surface, the CPU 20 further executes the scan processing 50 for the RIP data after the preprocessing 41, stores the data to the transfer area, and writes the data to the memory card 23M.

(Function F7) Scan_To_FAX

The scan_To_FAX function transmits data of an image read by the scanner device 13, using the communication interface 16 by facsimile communication. In the scan_To_FAX function, the CPU 20 stores the RIP data written in the image memory 23A after the preprocessing 36 to a facsimile communication data area of the storage device 23 by data storage processing 53. Thereafter, the CPU 20 generates data according to a facsimile transmission protocol from the stored data by transmission processing 54, and transmits the generated data by transmission processing 55.

(Function F8) Fax Print_To_Preview

The Fax print_To_preview function previews and displays an image received by facsimile communication on the display 11b. In the Fax print_To_preview function, the CPU 20 converts the RIP data generated by the FAX input processing 47 into low-resolution data for preview display. The CPU 20 displays the low-resolution data on the display 11b by preview display processing 57.

<B. Detection Processing 60>

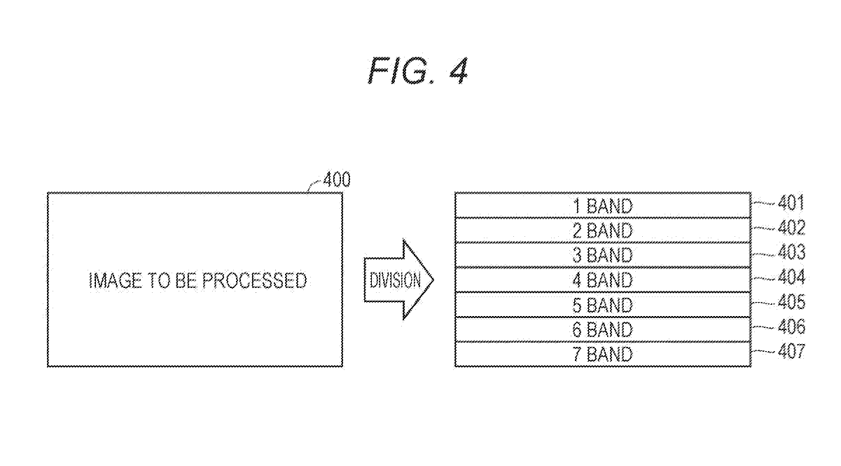

Next, the detection processing 60 will be described. The detection processing 60 includes detection determination processing 61 and job determination processing 62. In the detection determination processing 61, the CPU 20 writes the RIP data written in the image memory 23A to the buffer memory 23C. Data of a plurality of jobs are written to the buffer memory 23C so as to be processed at the same time as illustrated in FIG. 4 to be described below. Then, in the detection determination processing 61, the CPU 20 searches for the specific image pattern in the RIP data written in the buffer memory 23C. In the present specification, images of a plurality of jobs becoming objects to be processed in the detection processing 60 (detection determination processing 61) at the same time is also referred to as “multijob” in the detection processing.

The CPU 20 executes the functions F to F8 to the end on condition that the specific image pattern has not been detected in the detection determination processing 61.

That is, in the print function (function F1), the simplex scan/copy function (function F2), the duplex scan/copy function (function F3), and the FAX function (function F5), the CPU 20 prints the image to be processed on the recording sheet on condition that the specific image pattern has not been detected.

In the scan preview function (function F4) and the Fax print_To_preview function (function F8), the CPU 20 displays the preview image of the image to be processed on the display 11b on condition that the specific image pattern has not been detected.

In the scan_To_USB function (function F6), the CPU 20 stores the data of the image to be processed to the memory card 23M on condition that the specific image pattern has not been detected.

In the scan_To_FAX (function F7), the CPU 20 transmits the image to be processed by facsimile communication on condition that the specific image pattern has not been detected.

As described above, completion of the functions F1 to F8 waits for completion of the detection processing 60 (detection determination processing 61). When the time of the detection processing 60 (detection determination processing 61) is shortened, the time to complete the functions F1 to F8 is shortened.

When detecting the specific image pattern in the detection determination processing 61, the CPU 20 determines whether the specific image pattern is included in any of the plurality of jobs of which the data have been written in the buffer memory 23C in the job determination processing 62.

<C. Inhibition Processing 70>

The CPU 20 executes the inhibition processing 70 for the job determined to include the specific image pattern in the job determination processing 62. With the execution of the processing, an output of the image is inhibited in the functions F1 to F8 executed for the job.

An example of the inhibition is to output predetermined information instead of the image of the job. An example of outputting the predetermined information is to output dummy data. The dummy data is a message “an image of which output is prohibited is included” or white fill. As a result, in the functions F1 to F3 and F5, the dummy data is printed on the recording sheet instead of the image of the job. In the functions F4 and F8, the dummy data is displayed on the display 11b instead of the image of the job. In the function F6, a file including only the dummy data is written to the memory card 23M. In the function F7, an image including only the dummy data is transmitted by facsimile. That is, the job including the specific image pattern is not output and the predetermined information is output instead in the functions F1 to F8 in the inhibition processing 70.

Another example of the inhibition is to notify an error by display and/or sound on the image processing apparatus 1 instead of outputting the image of the job. With the notification, no job is output and the error is notified.

[3. Division of Image to be Processed]

FIG. 4 is a diagram schematically illustrating band division of an image in the detection processing 60. In the detection processing 60 (detection determination processing 61), the image (image to be processed) of each job is divided into bands of a predetermined size. In the example of FIG. 4, an image to be processed 400 is divided into seven bands 401 to 407. In the present specification, an image divided into band units is also referred to as “RIP band”. In this sense, in the example of FIG. 4, seven RIP bands generated from the image 400 are illustrated as the bands 401 to 407.

[4. Image Write to Buffer Memory 23C in Multijob]

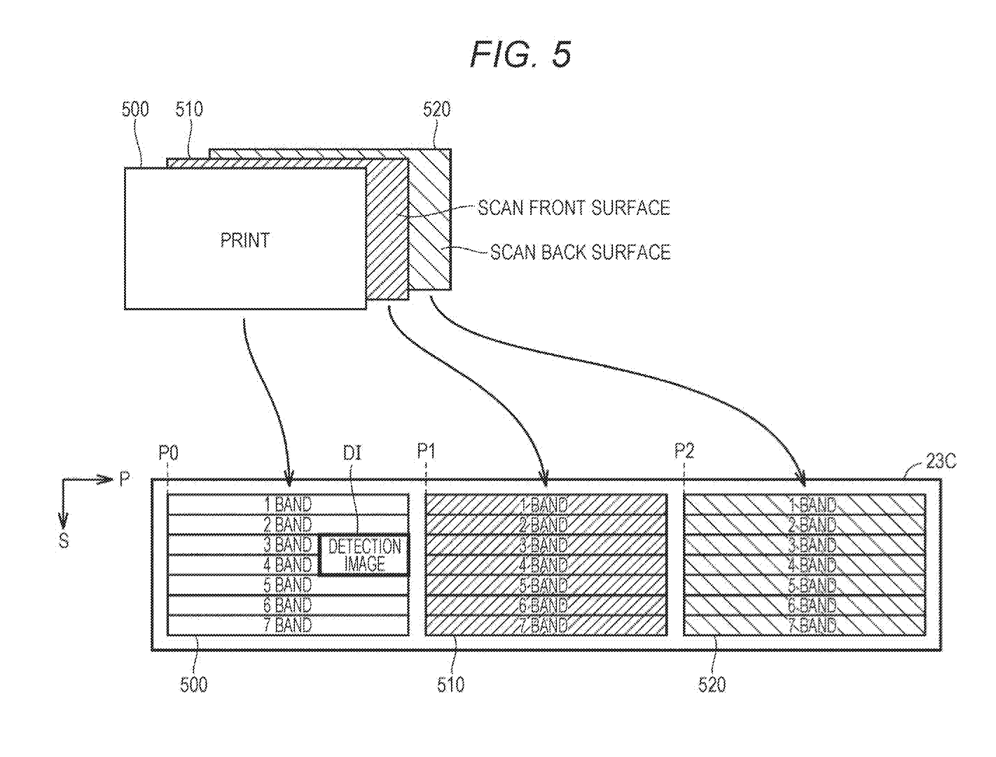

FIG. 5 is a diagram illustrating an example of writing an image to the buffer memory 23C in a case where the CPU 20 executes the detection processing 60 for a plurality of jobs at the same time. In the example of FIG. 5, images 500, 510, and 520 of three jobs to be processed are written in the buffer memory 23C in a state of being divided into band units. An example of the images of three jobs are an image of a print job, an image of a front surface of a document of a scan job, and an image of a back surface of the document of the scan job.

The print job is a job to print and output an image stored in the storage device 23 or an image input from an external device by the printer device 14. The scan job is a job to generate image data of a document by the scanner device 13. Another job handled by the image processing apparatus 1 includes a FAX job. The FAX job is a job to transmit and receive document data by FAX communication using the communication interface 16.

The CPU 20 may write the image to the buffer memory 23C at the same frequency as the image of each job written to the image memory 23A. For example, in the image processing apparatus 1, in a case where the frequency of writing to the image memory 23A in the scan job is set to 60 MHz, the CPU 20 writes the image in the image memory 23A to the buffer memory 23C at 60 MHz.

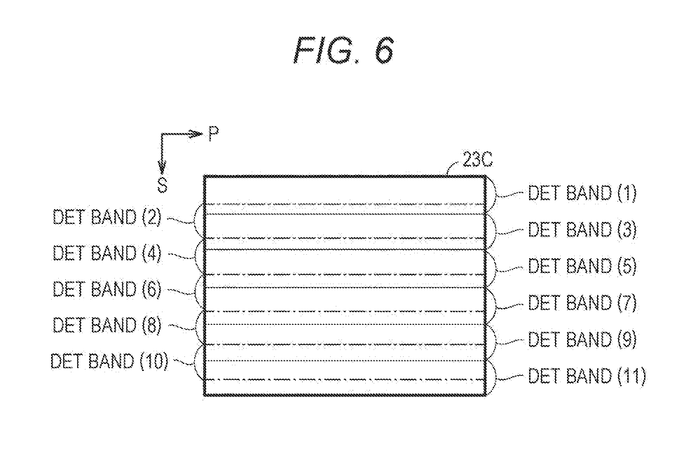

In FIG. 5, the arrow P represents a main scanning direction in the detection processing 60. The arrow S represents a sub-scanning direction in the detection processing 60. The execution unit of the detection processing 60 is constituted by an entire area in the main scanning direction and a predetermined width in the sub-scanning direction as represented by “DET band” in the description to be described below with reference to FIG. 6. The CPU 20 arranges the images 500, 510, and 520 in the sub-scanning direction in the buffer memory 23C.

FIG. 6 is a diagram illustrating an example of arrangement of the execution units in the detection processing 60. FIG. 6 illustrates eleven DET bands (1) to (11) set for the buffer memory 23C. Each DET band is the execution unit in the detection processing. For convenience, FIG. 6 illustrates the DET bands (1). (3), (5), (7), (9), and (11) by solid lines (thin lines), and the DET bands (2), (4), (6), (8), and (10) by alternate long and short dashed lines. Each DET band includes the entire area of the buffer memory 23C in the main scanning direction (arrow P direction) and includes a part of the buffer memory 23C in the sub-scanning direction (arrow S direction).

In an example of the detection processing 60, the CPU 20 changes the object to be processed in order of the DET band (1), the DET band (2), the DET band (3), and the like. As described with reference to FIG. 5, in the buffer memory 23C, the images of the plurality of jobs are arranged in the main scanning direction. With the setting of the execution unit as illustrated in FIG. 6, the CPU 20 can execute the detection processing 60 for the images of the plurality of jobs at the same time.

The CPU 20 executes the detection processing 60 for the images of the plurality of jobs at the same time (in parallel), whereby drastic reduction in the total time required for the detection processing for the plurality of jobs is realized in the image processing apparatus 1. For example, in the example of FIG. 5, the time required for the detection processing for the images 500, 510, and 520 is reduced to one third as compared with a case where the detection processing for the images 500, 510, and 520 is executed in series.

Returning to FIG. 5, each of the points P0, P1, and P2 indicates an offset position of each image in the main scanning direction of the buffer memory 23C. The offset position of the image 500 is the point P0, the offset position of the image 510 is the point P1, and the offset position of the image 520 is the point P2. Information specifying each of the points P0, P1, and P2 is stored in the storage device 23, for example.

In a case where the specific image pattern is detected in the detection processing 60, the CPU 20 specifies a job including the specific image pattern on the basis of the position of the image pattern in the main scanning direction. In the example of FIG. 5, the specific image pattern is illustrated as “detection image DI”. The detection image DI is located between the point P0 and the point P1 in the main scanning direction. From this, the CPU 20 specifies the job of the image 500 as the job including the specific image pattern from among the three jobs (the jobs of the images 500, 510, and 520) that are the objects for the detection processing 60.

Note that, even in a case where the detection processing 60 processes a plurality of jobs, the CPU 20 may not identify the job including the specific image pattern from among the plurality of jobs. In this case, if the CPU 20 executes the inhibition processing 70 for all the object jobs of the detection processing 60, an output of the job including the specific image pattern can be inhibited.

[5. Effects of Parallel Execution of Detection Processing for Plurality of Jobs]

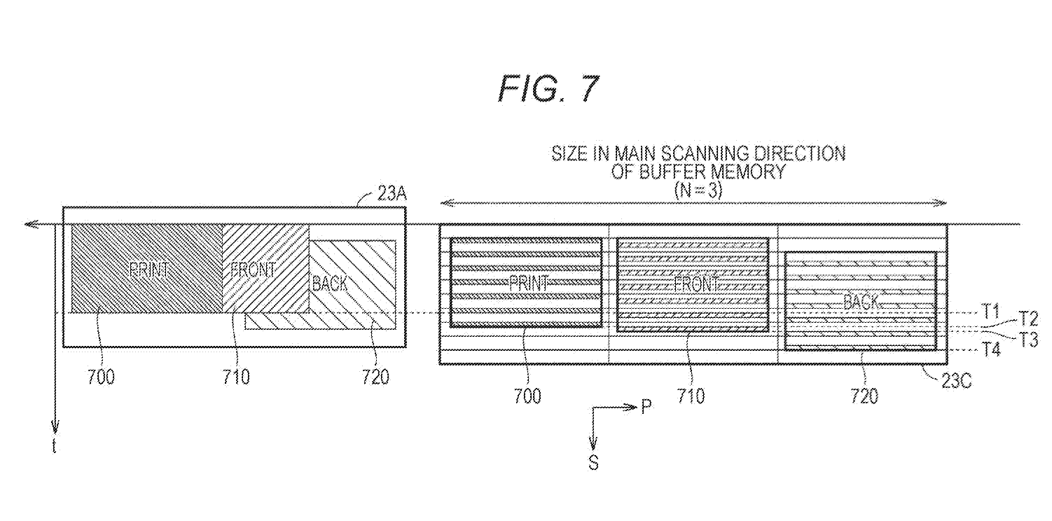

Effects obtained by executing the detection processing for a plurality of jobs in parallel will be described with reference to FIGS. 7 to 9.

FIG. 7 is a diagram for describing an example in which a difference occurs in timing when images are written to the buffer memory 23C among a plurality of jobs. The left side of FIG. 7 illustrates the difference in timing when images 700, 710, and 720 of three jobs are written to the image memory 23A. Note that FIG. 7 illustrates the image 700, the image 710, and the image 720 to overlap in the image memory 23A due to space limitation. However, in reality, the images are written independently of one another (without being superimposed on one another) in the image memory 23A.

The right side in FIG. 7 illustrates the difference in timing when images 700, 710, and 720 of three jobs are written to the buffer memory 23C. In the example of FIG. 7, each of the images 700, 710, and 720 written in the image memory 23A is divided into seven RIP bands in the buffer memory 23C. The image 700 is, for example, an image of a print job. The image 710 is, for example, an image on a front surface of a document generated by a scan job. The image 720 is, for example, an image on a back side of the document generated by the scan job.

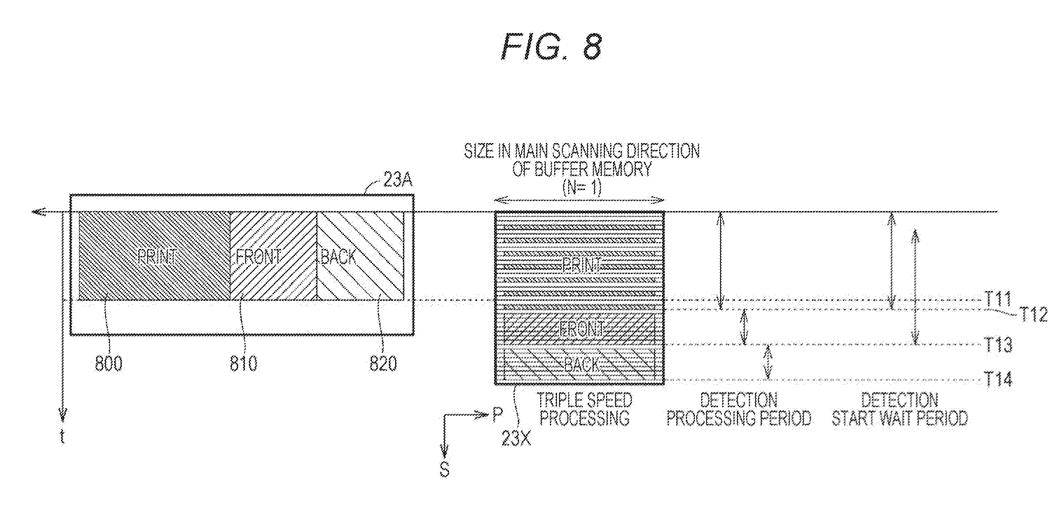

In FIG. 7, the same hatching is given to the RIP data of each image in the buffer memory 23C as that given to each image in the image memory 23A. This similarly applies to FIGS. 8 to 19.

In FIG. 7, the vertical axis represents the sub-scanning direction in the image memory 23A and the buffer memory 23C. In the image memory 23A and the buffer memory 23C, the written image spreads in the sub-scanning direction as time proceeds. Therefore, in FIG. 7, the vertical axis may also represent a time axis. In FIGS. 8 to 19, the vertical axis similarly represents the sub-scanning direction in the image memory 23A and the buffer memory 23C, and also represents the time axis.

In the example of FIG. 7, the CPU 20 starts the writing of the image 700 and the image 710 to the image memory 23A almost at the same time, and then starts writing the image 720 to the image memory 23A. The CPU 20 sequentially writes the images written in the image memory 23A to the buffer memory 23C, and sequentially executes the detection processing for the images written in the buffer memory 23C. As a result, as illustrated on the right side in FIG. 7, completion of the detection processing for the last RIP data of the image 720 is after completion of the detection processing for the last RIP data of the images 700 and 710.

In FIG. 7, a time T1 indicates a point of time when writing of the images 700 and 710 is completed to the image memory 23A. Times T2 and T3 respectively indicate points of time when the detection processing for the last RIP bands of the images 700 and 710 in the buffer memory 23C is completed. A time T4 indicates a point of time when the detection processing for the last RIP band of the image 720 in the buffer memory 23C is completed.

That is, in the example of FIG. 7, the start of the detection processing of each job is synchronized with the writing of the RIP band to the buffer memory 23C. Therefore, the completion of the detection processing of each job is also synchronized with the wiring of the RIP band to the buffer memory 23C. Therefore, execution of the detection processing 60 of each job becomes possible almost at the same time with an image processing process at the multijob (a process to output the image after the image data is written to the image memory 23A. For example, the print processing 33 in FIG. 3).

Further, images of the same job are continuously written in the sub-scanning direction in the buffer memory 23C. As a result, with the setting of the DET bands in the form illustrated in FIG. 6, omission of detection of the specific image pattern existing over two DET bands can be avoided as much as possible with respect to the images of each job.

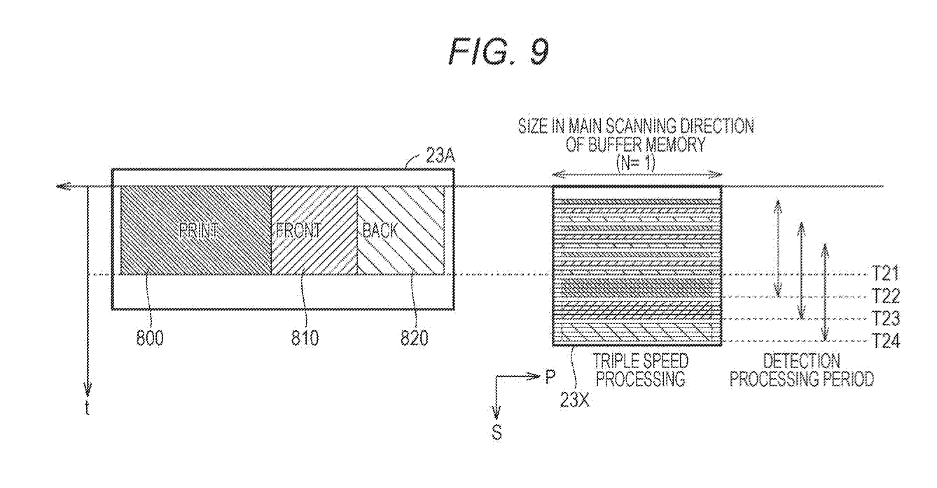

FIGS. 8 and 9 are diagrams for describing detection processing in comparative examples. In the examples of FIG. 8 and FIG. 9, a buffer memory 23X is illustrated as a comparative example of the buffer memory 23C. The dimension of the buffer memory 23X in the main scanning direction is set to correspond to the dimension of an image of one job and is set not to correspond to the dimension of images of a plurality of jobs.

The example of FIG. 8 corresponds to detection processing according to page interleaving. In the present specification, the page interleaving means switching an image to be processed in the detection processing in every page of each job. FIG. 8 illustrates images 800, 810, and 820 as objects to be detected. An example of the image 800 is an image of one page of a print job. An example of the image 810 is an image of one page on a front surface of a document of a scan job. An example of the image 820 is an image of one page on a back surface of the document of the scan job. In the example of FIG. 8, when band images of images (images 800, 810, and 820) are accumulated in the buffer memory 23X, a CPU 20 reserves detection processing 60 for each of the images 800, 810, and 820, and sequentially executes the detection processing 60 for each RIP band of the images 800, 810, and 820.

The detection processing 60 is reserved in page units of the job. Therefore, the CPU 20 executes the detection processing 60 for the RIP bands of the image 800, then executes the detection processing 60 for the RIP bands of the image 810, and then executes the detection processing 60 for the RIP bands of the image 820.

In the example of FIG. 8, regarding the image 800, completion (a time T12 in FIG. 8) of the detection processing 60 follows completion (a time T11 in FIG. 8) of the writing of the RIP data of the image 800 to the image memory 23A in almost real time. However, the detection processing 60 for the image 810 is started after the completion of the detection processing 60 for the image 800. Therefore, regarding the image 810, completion (a time T13 in FIG. 8) of the detection processing 60 is relatively significantly delayed from the writing of the RIP data of the image 810 to the image memory 23A. The detection processing 60 for the image 820 is executed after the completion of the detection processing 60 for the image 810. Therefore, regarding the image 820, completion (a time T14 in FIG. 8) of the detection processing 60 is further significantly delayed from the writing of the RIP data of the image 820 to the image memory 23A.

In FIG. 8, “triple speed processing” means that the speed of the detection processing 60 progressing in the sub-scanning direction is tripled as compared with the example of FIG. 7. That is, the number of pixels to be processed in the detection processing 60 in the main scanning direction is ⅓ in the example of FIG. 8, as compared with the example of FIG. 7. Therefore, the time required for the detection processing 60 for the RIP bands is reduced to about ⅓. For example, while the detection processing 60 is executed at the frequency of 10 MHz in the example of FIG. 7, the detection processing 60 is executed at the frequency of 30 MHz in the example of FIG. 8 (and in the example of FIG. 9 described below).

However, in the example of FIG. 8, the detection processing 60 cannot be executed in parallel for a plurality of jobs. Therefore, as for the images 810 and 820, the completion of the detection processing 60 is significantly delayed from the completion of the image processing processes such as the print processing 33 in FIG. 3.

The example of FIG. 9 corresponds to the detection processing according to band interleaving. In the present specification, the band interleaving means switching an image to be processed in the detection processing in every RIP band of each job. In the example of FIG. 9, every time data of an amount corresponding to an RIP band is written to the image memory 23A, the CPU 20 writes an image corresponding to the RIP band to the buffer memory 23X. The CPU 20 reserves the detection processing 60 in units of RIP bands. As a result, the RIP band to be processed in the detection processing 60 is changed such that the first RIP band of the image 800, the first RIP band of the image 810, the first RIP band of the image 820, the second RIP band of the image 800, the second RIP band of the image 810, the second RIP band of the image 820, the third RIP band of the image 800, and the like, as illustrated on the right side in FIG. 9, until the writing of the images 800, 810, and 820 to the image memory 23A is completed. That is, the images to be processed in the detection processing 60 are sequentially switched among the images 800, 810, and 820.

When the writing of the image 800 to the image memory 23A is completed (a time T21 in FIG. 9), the CPU 20 sequentially reserves the detection processing 60 for all the remaining RIP bands of the image 800. Further, when the writing of the images 810 and 820 to the image memory 23A is terminated, the CPU 20 sequentially reserves the detection processing 60 for all the remaining RIP bands of the images 810 and 820. Therefore, as illustrated on the right side in FIG. 9, after the detection processing 60 for the third RIP band of the image 820, the CPU 20 executes the detection processing 60 for the fourth RIP band of the image 800, and then the CPU 20 sequentially executes the detection processing 60 for the fifth to seventh RIP bands of the image 800. A time T22 indicates timing when the detection processing 60 for the seventh RIP band of the image 800 is completed.

After the completion of the detection processing 60 for the seventh RIP band of the image 800, the CPU 20 sequentially executes the detection processing 60 for the fourth to seventh RIP bands of the image 810. A time T23 indicates timing when the detection processing 60 for the seventh RIP band of the image 810 is completed.

After the completion of the detection processing 60 for the seventh RIP band of the image 810, the CPU 20 sequentially executes the detection processing 60 for the fourth to seventh RIP bands of the image 820. A time T24 indicates timing when the detection processing 60 for the seventh RIP band of the image 820 is completed.

In the example of FIG. 9, the time from the writing to the image memory 23A to the start of the detection processing 60 is reduced for the images 810 and 820, as compared with the example of FIG. 8. However, the first to third RIP bands of the images are discontinuously processed in the detection processing 60. Therefore, in a case where the specific image pattern exists over adjacent RIP bands, a possibility that the specific image pattern is not detected occurs.

Further, in the example of FIG. 9, a time difference occurs in the completion of the detection processing 60 among a plurality of jobs of which the data have been written to the image memory 23A at the same time. That is, the times when the detection processing 60 of the respective images 800, 810, and 820 is completed are the times T22, T23, and T24, as illustrated in FIG. 9. Therefore, as for a part (for example, the image 820) of the plurality of jobs of which the data have been written to the image memory 23A at the same time, the delay of the completion of the detection processing 60 may affect the performance in the image processing apparatus 1. Meanwhile, in the example of FIG. 7, even if there is some difference in the timing when the images are written to the image memory 23A among the images 700, 710, and 720, the difference in time of the completion of the detection processing 60 among the images 700, 710, and 720 is suppressed to the minimum. Therefore, the influence of the detection processing 60 on the performance in the image processing apparatus 1 is suppressed to the minimum regarding all the jobs.

[6. Case where Number of Jobs Executed at Same Time is “2” and Each Job has One Page]

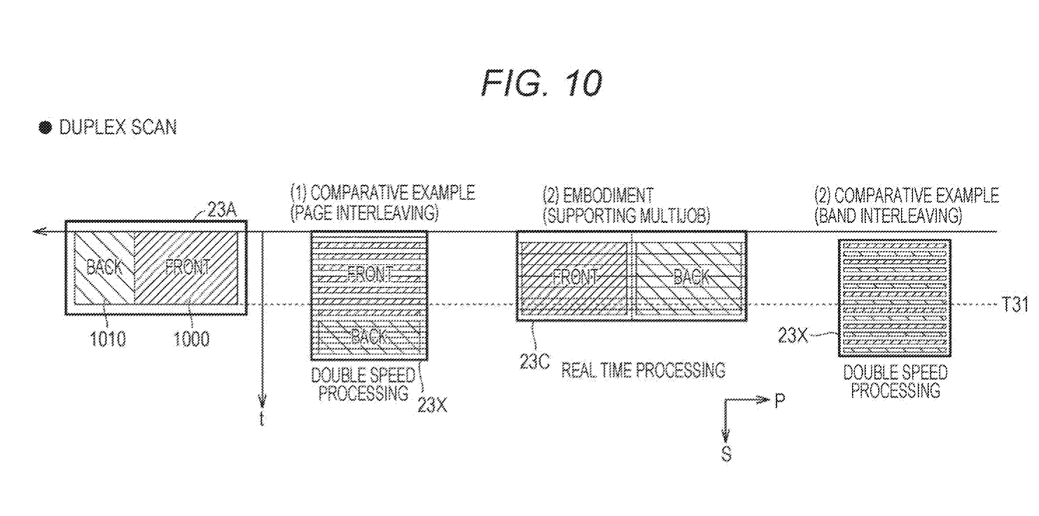

FIGS. 10 to 12 are diagrams for describing effects of a case where the number of jobs for which the detection processing 60 is executed at the same time is “2” and each job includes an image of one page in the present embodiment

Each of FIGS. 10 to 12 illustrates, from the left, a mode of writing data in the image memory 23A, a state of progress of the detection processing according to the page interleaving ((1) comparative example), a state of progress of the detection processing according to the present embodiment ((2) embodiment), and a state of progress of the detection processing according to the band interleaving ((3) comparative example).

FIG. 10

In the example of FIG. 10, an image 1000 on a front surface of a document and an image 1010 on a back surface of the document generated by the duplex scanning of the document are objects for the detection processing. In the example of FIG. 10, at a time T31, writing of data of the image 1000 and the image 1010 to the image memory 23A is completed.

“Double speed processing” in (1) comparative example in FIG. 10 means that the speed of the detection processing 60 progressing in the sub-scanning direction is doubled as compared with (2) embodiment. That is, the number of pixels to be processed in the detection processing 60 in the main scanning direction is ½ in (1) comparative example, as compared with (2) embodiment. Therefore, the time required for the detection processing 60 for the RIP bands is reduced to about ½. For example, while the detection processing 60 is executed at the frequency of 10 MHz in (2) embodiment, the detection processing 60 is executed at the frequency of 20 MHz in (1) comparative example.

In (2) embodiment, the detection processing 60 is sequentially performed for the RIP bands of both the image 1000 and the image 1010 by the time T31. With the execution of the processing, in (2) embodiment, the detection processing 60 for the last RIP data of the image 1000 and the image 1010 is completed after the time T31, whereby the detection processing 60 for the image 1000 and the image 1010 is completed.

Meanwhile, in (1) comparative example, after the detection processing for all the RIP bands of the image 1000 is executed, the detection processing for the first RIP band of the image 1010 is started. In (1) comparative example, after the time T31, detection of the last RIP band of the image 1000 is executed, and thereafter, the detection processing for all the RIP bands of the image 1010 is executed. The completion of the detection processing for the image 1010 is delayed in (1) comparative example, as compared with (2) embodiment

In (3) comparative example, the detection processing for the RIP band of the image 1000 and the detection processing for the RIP band of the image 1010 are alternately performed. In (3) comparative example, completion of the detection processing for the last RIP band of the image 1010 is earlier than that in (1) comparative example. However, in (3) comparative example, completion of the detection processing for the last RIP bands of the image 1000 and the image 1010 is later than that in (2) embodiment. Further, in (3) comparative example, the detection processing for the continuous RIP bands in each of the image 1000 and the image 1010 is not continuously executed, and thus the accuracy of detection of the specific image pattern may be decreased as compared with (2) embodiment.

That is, as illustrated in FIG. 10, the detection processing for all the images can be completed early and the specific image pattern can be detected with high accuracy according to the present embodiment ((2) embodiment).

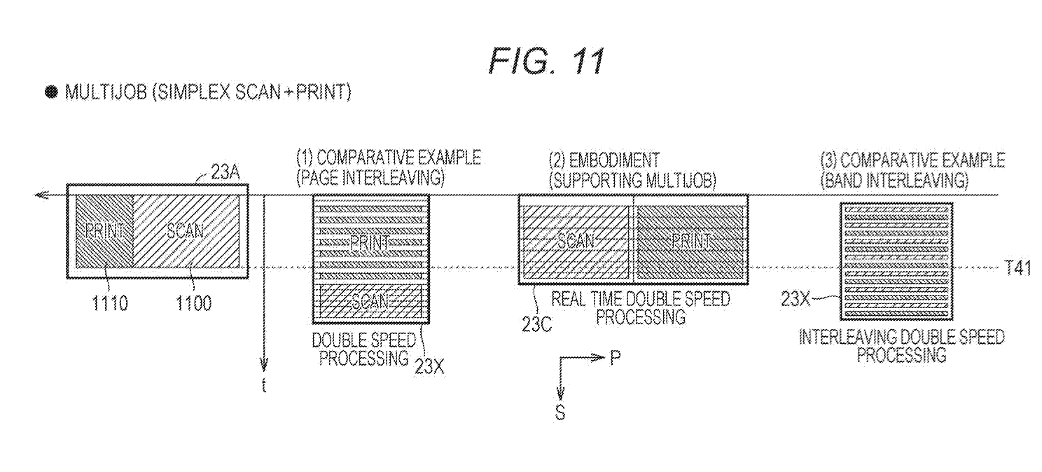

FIG. 11

In the example of FIG. 11, an image 1100 generated by the simplex scanning of a document and an image 1110 that is an object to be printed are objects for the detection processing. In the example of FIG. 11, at a time T41, writing of data of the image 1100 and the image 1110 to the image memory 23A is completed.

In the example of FIG. 11, in (2) embodiment, the detection processing 60 for the last RIP data of the image 1100 and the image 1110 is completed after the time T41, whereby the detection processing 60 for the image 1100 and the image 1110 is completed, similarly to the example of FIG. 10.

The completion of the detection processing for the image 1110 is delayed in (1) comparative example, as compared with (2) embodiment. In (3) comparative example, completion of the detection processing for the last RIP band of the image 1110 is earlier than that in (1) comparative example. However, in (3) comparative example, completion of the detection processing for the last RIP bands of the image 1100 and the image 1110 is later than that in (2) embodiment. Further, in (3) comparative example, the detection processing for the continuous RIP bands in each of the image 1100 and the image 1110 is not continuously executed, and thus the accuracy of detection of the specific image pattern may be decreased as compared with (2) embodiment.

That is, as illustrated in FIG. 11, the detection processing for all the images can be completed early and the specific image pattern can be detected with high accuracy according to the present embodiment ((2) embodiment).

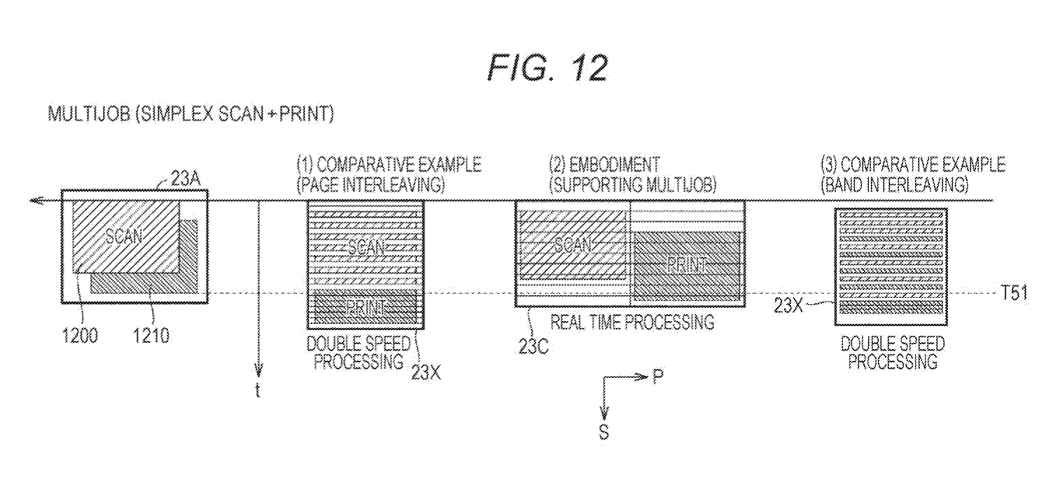

FIG. 12

In the example of FIG. 12, an image 1200 and the image 1210 are objects for the detection processing, similarly to the example of FIG. 11. In the example of FIG. 12, there is a difference in timing when writing to the image memory 23A is started between the image 1200 and the image 1210. After the start of the writing of the image 1210 to the image memory 23A, the writing of the image 1200 to the image memory 23A is started. In the example of FIG. 12, at a time T51, the writing of the image 1200 to the image memory 23A is completed.

In the example of FIG. 12, in (2) embodiment, when the writing of a part of the image 1210 to the image memory 23A is completed, the CPU 20 executes the detection processing for the part of the image. Thereafter, when the image 1200 is written to the image memory 23A in addition to the image 1210, the CPU 20 executes the detection processing for the image 1200 and the image 1210 at the same time. The detection processing for the last RIP band of the image 1200 is completed later than the detection processing for the last RIP band of the image 1210.

In (1) comparative example, after the detection processing for the image 1210, the detection processing for the image 1200 is started. Therefore, completion of the detection processing for the last RIP band of the image 1200 in (1) comparative example is later than completion of the detection processing for the last RIP band of the image 1200 in (2) embodiment.

In (3) comparative example, the detection processing for the first RIP band of the image 1210 is started after the detection processing for the third RIP band of the image 1200. Thereafter, the detection processing for the RIP band of the image 1200 and the detection processing for the RIP band of the image 1210 are alternately executed. Therefore, in (3) comparative example, the detection processing for the last RIP band of the image 1210 is completed earlier than that in (1) comparative example. However, in (3) comparative example, completion of the detection processing for the last RIP band of the image 1210 is later than that in (2) embodiment. Further, in (3) comparative example, the detection processing for continuous RIP bands in each of the image 1200 and the image 1210 is not partially continuously executed. Therefore, there is a possibility of a decrease in the accuracy of the detection of the specific image pattern as compared with (2) embodiment.

That is, according to the example of FIG. 12, the detection processing for all the images can be completed early and the specific image pattern can be detected with high accuracy according to the present embodiment ((2) embodiment).

[7. Case where Number of Jobs Executed at Same Time is “3” and Each Job has One Page]

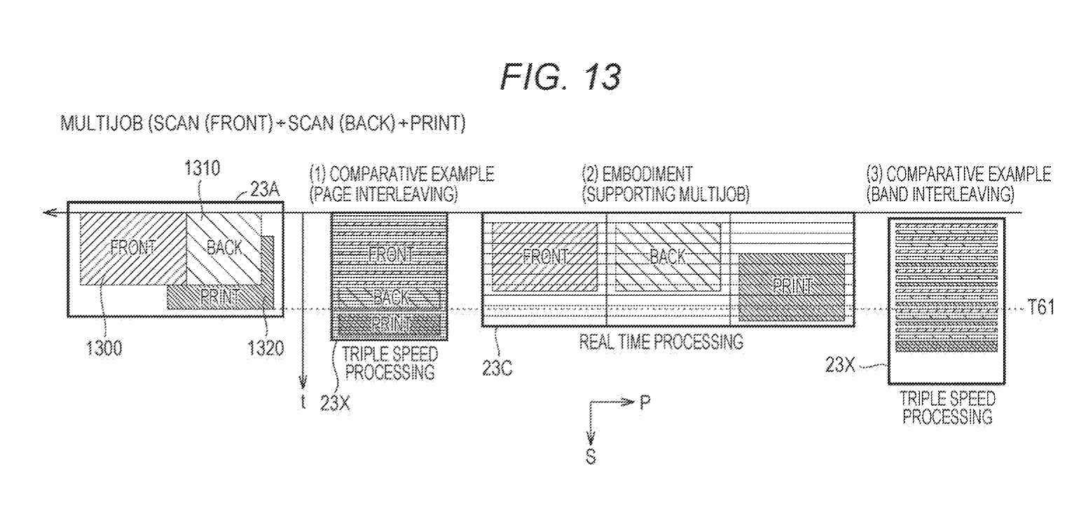

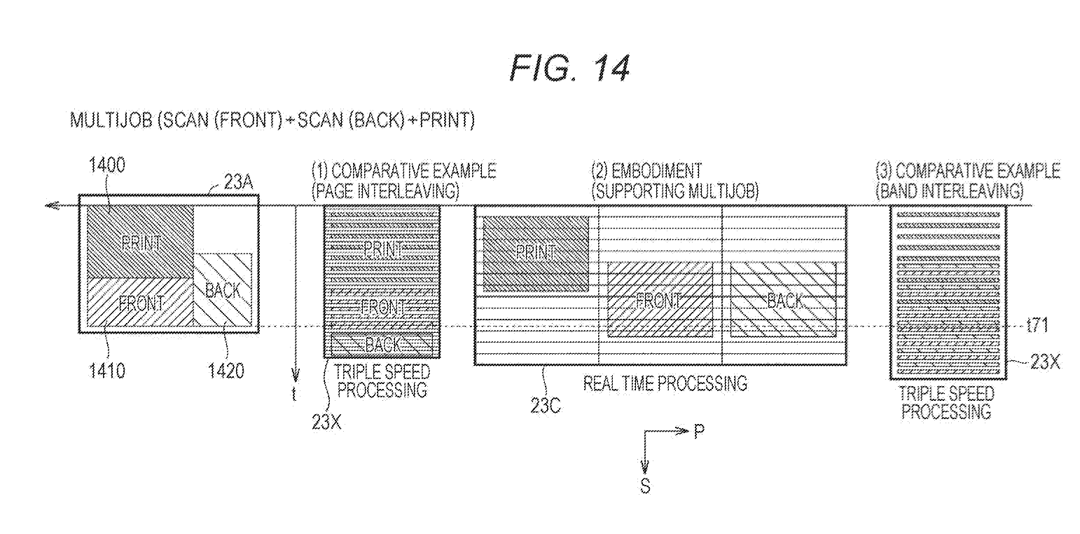

FIGS. 13 and 14 are diagrams for describing effects of a case where the number of jobs for which the detection processing 60 is executed at the same time is “3” and each job includes an image of one page in the present embodiment

Each of FIGS. 13 and 14 illustrates, from the left, a mode of writing data in the image memory 23A, a state of progress of the detection processing according to the page interleaving ((1) comparative example), a state of progress of the detection processing according to the present embodiment ((2) embodiment), and a state of progress of the detection processing according to the band interleaving ((3) comparative example).

FIG. 13

In the example of FIG. 13, images 1300, 1310, and 1320 are objects for the detection processing. The images 1300 and 1310 are respectively images on a front surface and on a back surface of a document, which are generated by duplex scanning of the document. The image 1320 is an image of a print job.

In the example of FIG. 13, after the start of writing of the images 1300 and 1310 to the image memory 23A, writing of the image 1320 to the image memory 23A is started. In the example of FIG. 13, at a time T61, the writing of the image 1320 to the image memory 23A is completed.

In (2) embodiment, when the writing of part of the images 1300 and 1310 to the image memory 23A is completed, the CPU 20 executes the detection processing for the part of the images. Thereafter, when the image 1320 is written to the image memory 23A in addition to the images 1300 and 1310, the CPU 20 executes the detection processing for the images 1300, 1310, and 1320 at the same time. The detection processing for the last RIP band of the image 1320 is completed later than the detection processing for the last RIP bands of the images 1300 and 1310.

In (1) comparative example, after the detection processing for the images 1300 and 1310, the detection processing for the image 1320 is started. Therefore, completion of the detection processing for the last RIP band of the image 1320 in (1) comparative example is later than completion of the detection processing for the last RIP band of the image 1320 in (2) embodiment.

In (3) comparative example, after the detection processing for the first three RIP bands of the images 1300 and 1310 is alternately executed, the detection processing for the first RIP band of the image 1320 is started. Thereafter, the detection processing for the RIP bands of the images 1300, 1310, and 1320 is alternately executed. Finally, the detection processing for three RIP bands of the image 1320 is continuously executed. Therefore, in (3) comparative example, the detection processing for the last RIP band of the image 1320 is completed earlier than that in (1) comparative example. However, in (3) comparative example, completion of the detection processing for the last RIP band of the image 1320 is later than that in (2) embodiment. Further, in (3) comparative example, the detection processing for continuous RIP bands in each of the images 1300, 1310, and 1320 is not partially continuously executed. Therefore, there is a possibility of a decrease in the accuracy of the detection of the specific image pattern as compared with (2) embodiment.

That is, according to the example of FIG. 13, the detection processing for all the images can be completed early and the specific image pattern can be detected with high accuracy according to the present embodiment ((2) embodiment).

FIG. 14

In the example of FIG. 14, images 1400, 1410, and 1420 are objects for the detection processing. The image 1400 is an image of a print job. The images 1410 and 1420 are respectively images on a front surface and on a back surface of a document, which are generated by duplex scanning of the document.

In the example of FIG. 14, after the start of writing of the image 1400 to the image memory 23A, writing of the images 1410 and 1420 to the image memory 23A is started. In the example of FIG. 14, at a time T71, the writing of the images 1410 and 1420 to the image memory 23A is completed.

In (2) embodiment, when the writing of part of the image 1400 to the image memory 23A is completed, the CPU 20 executes the detection processing for the part of the image. Thereafter, when the images 1410 and 1420 are written to the image memory 23A in addition to the image 1400, the CPU 20 executes the detection processing for the images 1400, 1410, and 1420 at the same time. The detection processing for the last RIP bands of the images 1410 and 1420 is completed later than the detection processing for the last RIP band of the image 1400.

In (1) comparative example, after the detection processing for the images 1400 and 1410, the detection processing for the image 1420 is started. Therefore, completion of the detection processing for the last RIP band of the image 1420 in (1) comparative example is later than completion of the detection processing for the last RIP band of the image 1420 in (2) embodiment.

In (3) comparative example, after the detection processing for the first five RIP bands of the image 1400 is executed, the detection processing for the RIP bands of the images 1400, 1410, and 1420 are alternately executed. When the detection processing for the RIP band of the image 1400 is completed, the detection processing for the RIP bands of the images 1410 and 1420 is alternately executed. Therefore, in (3) comparative example, the detection processing for the last RIP bands of the images 1410 and 1420 is completed earlier than that in (1) comparative example. However, in (3) comparative example, completion of the detection processing for the last RIP bands in each of the images 1410 and 1420 is later than that in (2) embodiment. Further, in (3) comparative example, the detection processing for continuous RIP bands in each of the images 1400, 1410, and 1420 is not partially continuously executed. Therefore, there is a possibility of a decrease in the accuracy of the detection of the specific image pattern as compared with (2) embodiment.

That is, according to the example of FIG. 14, the detection processing for all the images can be completed early and the specific image pattern can be detected with high accuracy according to the present embodiment ((2) embodiment).

[8. Case where Each of Plurality of Jobs has Plurality of Pages]

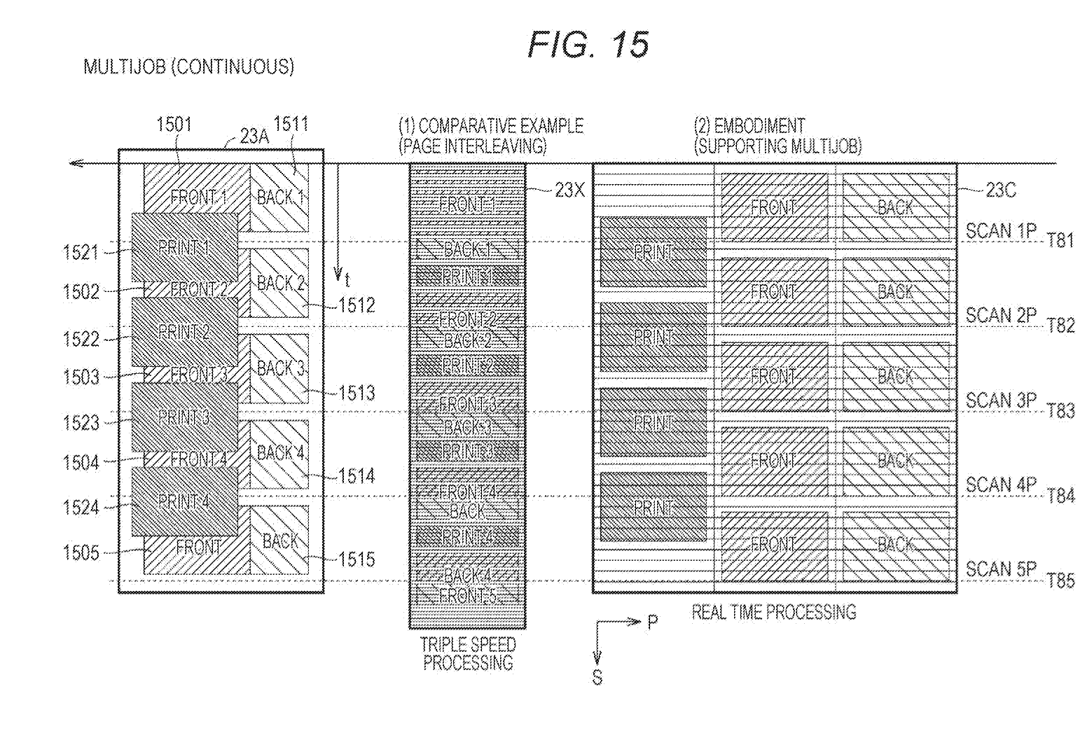

FIGS. 15 to 19 illustrate cases where each of a plurality of jobs for which the detection processing is executed at the same time has a plurality of pages in the present embodiment.

FIG. 15

In the example of FIG. 15, three jobs are objects for the detection processing. The first job includes images 1501 to 1505 of five pages on front surfaces of a document generated by scanning. Each of the five images 1501 to 1505 corresponds to an image of one page. The second job includes images 1511 to 1515 of five pages on back surfaces of the document generated by scanning. Each of the five images 1511 to 1515 corresponds to an image of one page. The third job includes images 1521 to 1524 of four pages of a print job. Each of the four images 1521 to 1524 corresponds to an image of one page.

FIG. 15 illustrates a state of progress of the detection processing according to the page interleaving ((1) comparative example) and a state of progress of the detection processing according to the present embodiment ((2) embodiment).

In (1) comparative example, the detection processing for the three jobs is alternately executed for each page. The detection processing for the image 1511 is not started until the detection processing of the image 1501 is completed.

Meanwhile, in (2) embodiment, the detection processing for the image 1501 and the image 1502 is started at the same time. In (2) embodiment, times T81, T82, T83, T84, and T85 respectively indicate timing when the detection processing for the respective images 1501, 1502, 1503, 1504, and 1505 (images 1511, 1512, 1513, 1514, and 1515) is completed. In (2) embodiment, the detection processing for the image 1501 and the image 1511 is started at the same time. Further, the detection processing for the three jobs is executed at the same time.

As a result, the detection processing for all the images is completed earlier in (2) embodiment than that in (1) comparative example.

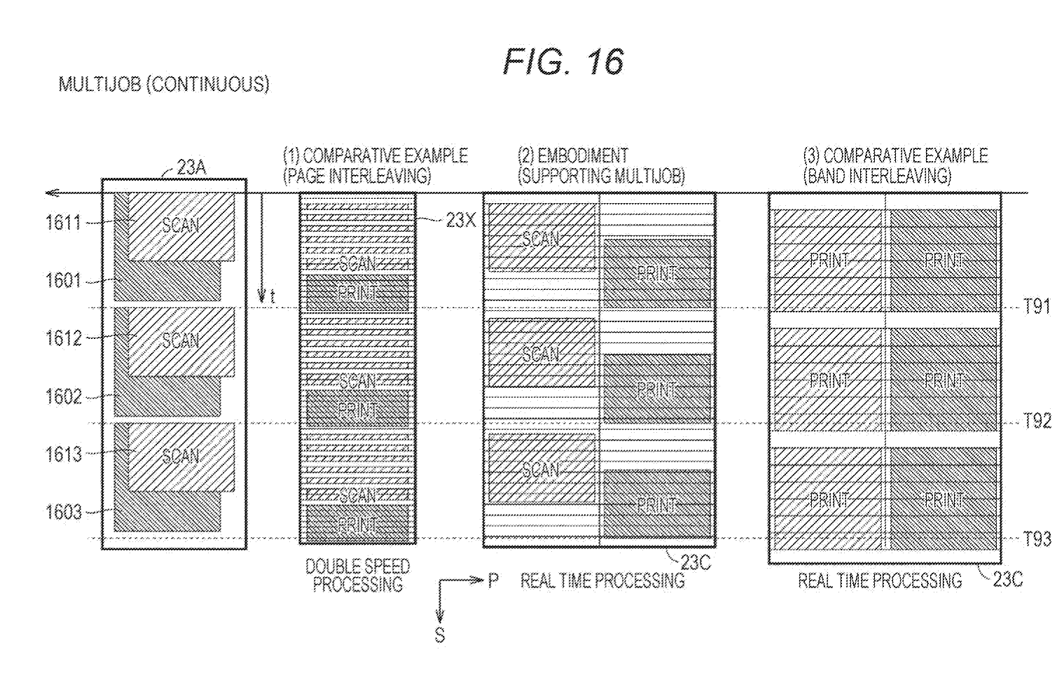

FIG. 16

In the example of FIG. 16, frequencies at which data is written to the image memory 23A are different for images of a plurality of jobs for which the detection processing is executed at the same time. In FIG. 16, the first job is a print job and includes images 1601 to 1603. The second job includes the images 1611 to 1613 on front surfaces of a document generated by scanning.

FIG. 16 illustrates, from the left, a mode of writing data in the image memory 23A, a state of progress of the detection processing according to the page interleaving ((1) comparative example), and respective states of progress of two examples of the detection processing according to the present embodiment ((2-1) embodiment and (2-2) embodiment).

In the example of FIG. 16, the frequency of writing to the image memory 23A in the print job is 40 MHz, and the frequency of writing to the image memory 23A in the scan job is 60 MHz. From the above, the time required for writing each of the images 1601 to 1603 of the print job to the image memory 23A is longer than the time to write each of the images 1611 to 1613 of the scan job to the image memory 23A. Times T91, T92, and T93 respectively indicate times when the writing of the respective images 1601, 1602, and 1603 of the print job to the image memory 23A is completed.

In (2-1) embodiment, the CPU 20 writes an image to the buffer memory 23C at a frequency according to the job with a higher frequency of writing to the image memory 23A, and executes the detection processing. As a result, even when the writing of both the image 1601 of the print job and the image 1611 of the scan job to the image memory 23A are started at the same time, the CPU 20 executes the detection processing for the first RIP band of the image 1611 of the scan job in advance of the first RIP band of the image 1601 of the print job. Thereafter, as the writing of the image 1601 to the image memory 23A progresses, the CPU 20 executes the detection processing for the RIP bands of both the image 1611 and the image 1601 at the same time.

In (2-2) embodiment, the CPU 20 writes an image to the buffer memory 23C at a frequency according to the job with a lower frequency of writing to the image memory 23A, and executes the detection processing. When data of one RIP band of the print job is written to the image memory 23A after data of one RIP band of the scan job is written to the image memory 23A, the CPU 20 executes the detection processing for the images of the data. Note that in (2-2) embodiment, in the image processing apparatus 1, a delay buffer for delaying the timing of the detection processing is required for data to become the object for the detection processing after written to the image memory 23A, of the data of the scan job.

In (1) comparative example, the CPU 20 alternately executes the detection processing for the image of each page of the scan job and the image of each page of the print job. Meanwhile, in both of (2-1) embodiment and (2-2) embodiment the detection processing for the images of the two jobs is executed at the same time for at least part of the RIP data. Therefore, a time when the detection processing for both the images 1601 and 1611 is completed from the time T91 is shorter in (2-1) embodiment and (2-2) embodiment than in (1) comparative example. Further, a time when the detection processing for both the images 1602 and 1612 is completed from the time T92, and a time when the detection processing for both the images 1603 and 1613 is completed from the time T93 are similarly shorter in (2-1) embodiment and (2-2) embodiment than in (1) comparative example. That is, in (2-1) embodiment and (2-2) embodiment, the time required for the detection processing for all the images can be shortened as compared with (1) comparative example.

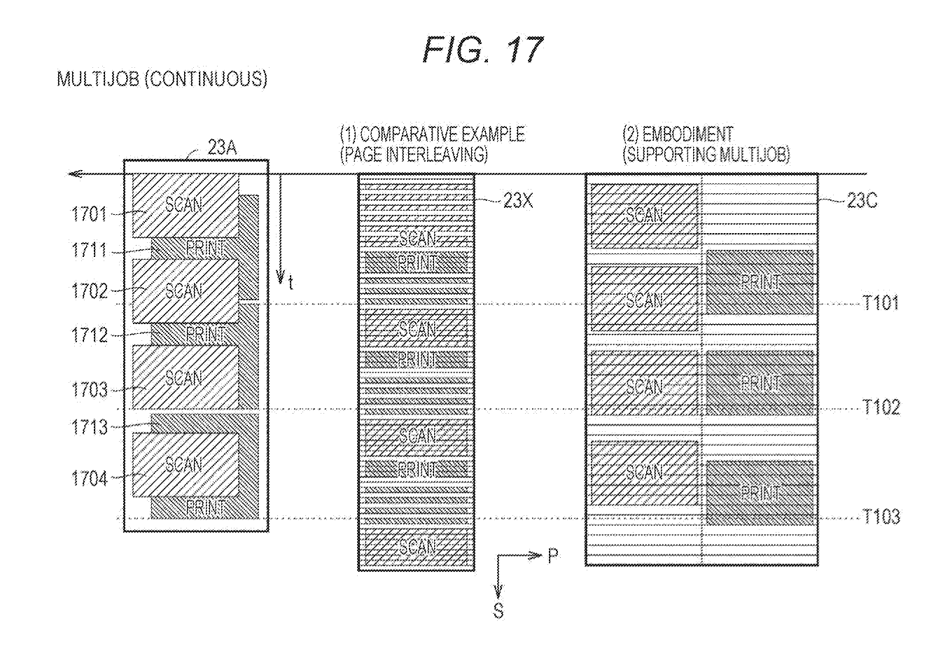

FIG. 17

In the example of FIG. 17, images of a scan job and images of a print job are objects for the detection processing. The scan job includes images 1701 to 1704. The print job includes images 1711 to 1713. In FIG. 17, times T101, T102, and T103 respectively indicate times when writing of the respective images 1711, 1712, and 1713 to the image memory 23A is completed.

The frequency of writing of the images of the scan job to the image memory 23A is 60 MHz, and the frequency of writing of the images of the print job to the image memory 23A is 40 MHz. In the example of FIG. 17, the writing of the image of the scan job to the image memory 23A is started earlier than the writing of the image of the print job to the image memory 23A.

FIG. 17 illustrates, from the left, a mode of writing data in the image memory 23A, a state of progress of the detection processing according to the page interleaving ((1) comparative example), and a state of progress of the detection processing according to the present embodiment ((2) embodiment).

As illustrated in (2) embodiment, the CPU 20 sequentially executes the detection processing for only the image 1701 when the image 1701 of the scan job is written to the image memory 23A. Thereafter, the CPU 20 executes the detection processing for both the image 1702 of the scan job and the image 1711 of the print job at the same time when the image 1711 of the print job is written to the image memory 23A. Further, the CPU 20 executes the detection processing for both the image 1703 of the scan job and the image 1712 of the print job at the same time, and executes the detection processing for both the image 1704 of the scan job and the image 1713 of the print job at the same time.

Meanwhile, in (1) comparative example, the detection processing for the images of pages is sequentially executed in order of the images 1701, 1711, 1702, 1712, 1703, 1713, and 1704. Further, in (1) comparative example, the start of execution of the detection processing for the fourth and subsequent RIP data of each image is delayed for the images of the print job with a low frequency of writing to the image memory 23A. From the above, in (2) embodiment, the detection processing for all the images is completed earlier than (1) comparative example.

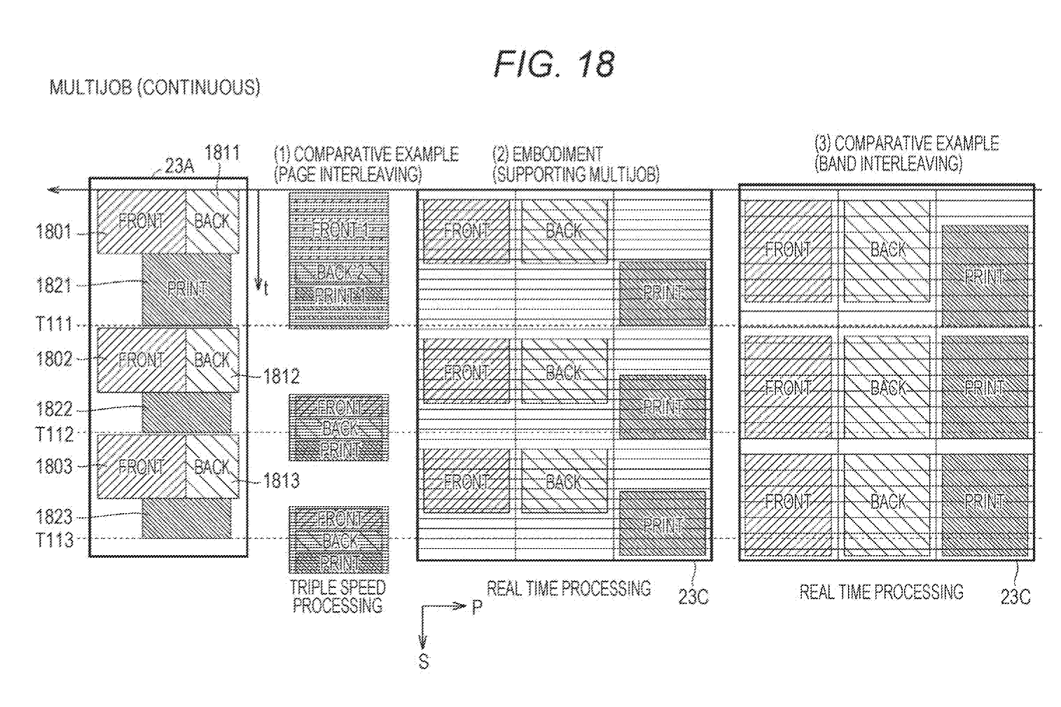

FIG. 18

In the example of FIG. 18, images on front surfaces of a scan job, images on back surfaces of the scan job, and images of a print job are objects for the detection processing. The images on the front surfaces of the scan job include images 1801 to 1803. The images on the back surfaces of the scan job include images 1811 to 1813. The print job includes images 1821 to 1823.

FIG. 18 illustrates, from the left, a mode of writing data in the image memory 23A, a state of progress of the detection processing according to the page interleaving ((1) comparative example), and respective states of progress of two examples of the detection processing according to the present embodiment ((2-1) embodiment and (2-2) embodiment).

In the example of FIG. 18, the frequency of writing of the images of the scan job to the image memory 23A is 60 MHz, and the frequency of writing of the images of the print job to the image memory 23A is 40 MHz. Therefore, in the example of FIG. 18, the image of each page of the print job is written to the image memory 23A with a delay from the images of each pages on the front surface and the back surface of the scan job. In FIG. 18, times T111, T112, and T113 respectively indicate times when writing of the respective images 1821, 1822, and 1823 to the image memory 23A is completed.

In (2-1) embodiment, the CPU 20 writes an image to the buffer memory 23C at a frequency according to the job with a higher frequency of writing to the image memory 23A, and executes the detection processing. The CPU 20 sequentially executes the detection processing for RIP bands of the images 1801 and 1811 at the same time according to the writing of the images 1801 and 1811 to the image memory 23A. Thereafter, when the image 1821 is written to the image memory 23A, the CPU 20 executes the detection processing for RIP bands of the image 1821. The CPU 20 sequentially executes the detection processing for RIP bands of the images 1802 and 1812 at the same time according to the writing of the images 1802 and 1812 to the image memory 23A. Thereafter, when the image 1822 is written to the image memory 23A, the CPU 20 executes the detection processing of the images 1802, 1812, and 1822 at the same time.

In (2-2) embodiment, the CPU 20 writes an image to the buffer memory 23C at a frequency according to the job with a lower frequency of writing to the image memory 23A, and executes the detection processing. In (2-2) embodiment, parts to be the objects for the detection processing at the same time increase between the images 1801 and 1811 and the image 1821, as compared with (2-1) embodiment. This similarly applies to between the images 1802 and 1812 and the image 1822, and between the images 1803 and 1813 and the image 1823. Thereby, the detection processing for all the images is completed earlier in (2-2) embodiment than that in (2-1) embodiment. Note that, in (2-2) embodiment, in the image processing apparatus 1, a delay buffer for delaying the timing of the detection processing is required for data to become the object for the detection processing after written to the image memory 23A, of the data of the scan job.

In (1) comparative example, the CPU 20 executes the detection processing in turn for each job for the image of each page on the front surface of the scan job, the image of each page on the back surface of the scan job, and the image of each page of the print job. Thereby, the time required for the detection processing for all the images is longer in (1) comparative example than that in (2-1) embodiment and (2-2) embodiment. In other words, in (2-1) embodiment and (2-2) embodiment, the time required for the detection processing for all the images can be shortened, as compared with (1) comparative example.

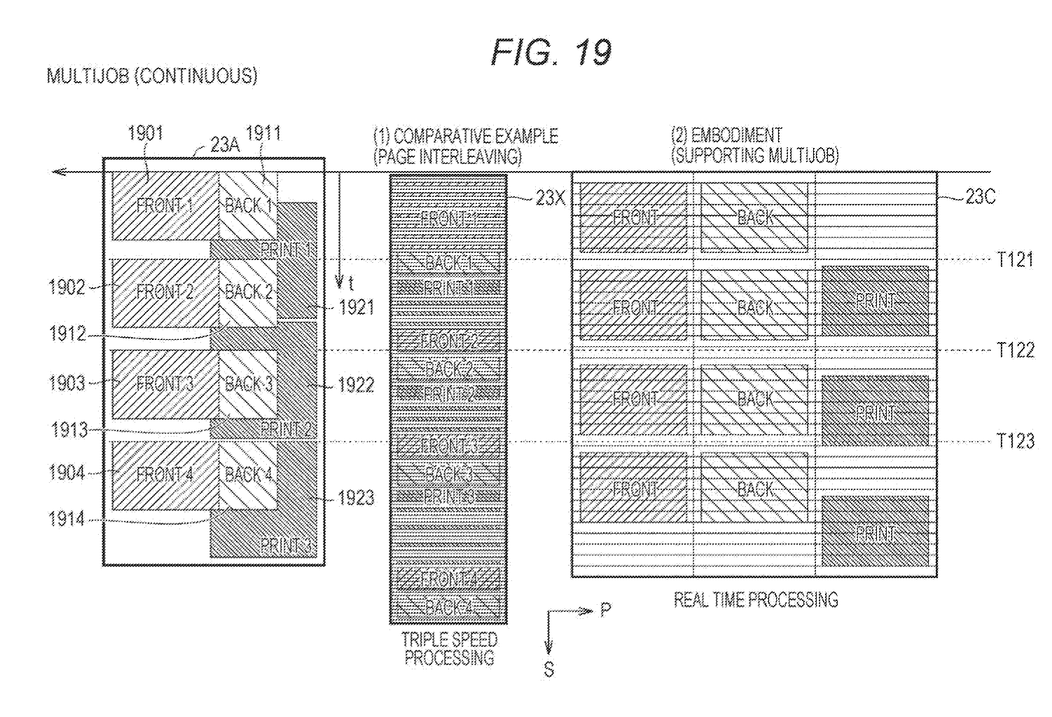

FIG. 19

In the example of FIG. 19, images on front surfaces of a scan job, images on back surfaces of the scan job, and images of a print job are objects for the detection processing. The images on the front surfaces of the scan job include images 1901 to 1904. The images on the back surfaces of the scan job include images 1911 to 1914. The print job includes images 1921 to 1923.

FIG. 19 illustrates, from the left, a mode of writing data in the image memory 23A, a state of progress of the detection processing according to the page interleaving ((1) comparative example), and a state of progress of the detection processing according to the present embodiment ((2) embodiment). In the example of FIG. 19, the frequency of writing of the images of the scan job to the image memory 23A is 60 MHz, and the frequency of writing of the images of the print job to the image memory 23A is 40 MHz. In (2) embodiment, the CPU 20 writes an image to the buffer memory 23C at a frequency according to the job with a higher frequency of writing to the image memory 23A, and executes the detection processing.

In the example of FIG. 19, the interval in which each page of the scan job is written to the image memory 23A is shorter than the example of FIG. 18. Thereby, in (2) embodiment of FIG. 19, the CPU 20 can execute the detection processing at the same time for a larger number of RIP bands for the images (the images 1902, 1912, and 1921, the images 1903, 1913, and 1922, the images 1904, 1914, and 1923) of the three jobs than (2-1) embodiment in FIG. 18. Thereby, in (2) embodiment of FIG. 19, the effect of time reduction of the detection processing for the comparative example according to the page interleaving is more significantly exhibited than (2-1) embodiment in FIG. 18. That is, the time for the detection processing is further shortened for the comparative example according to the page interleaving.

[9. Flow of Processing]

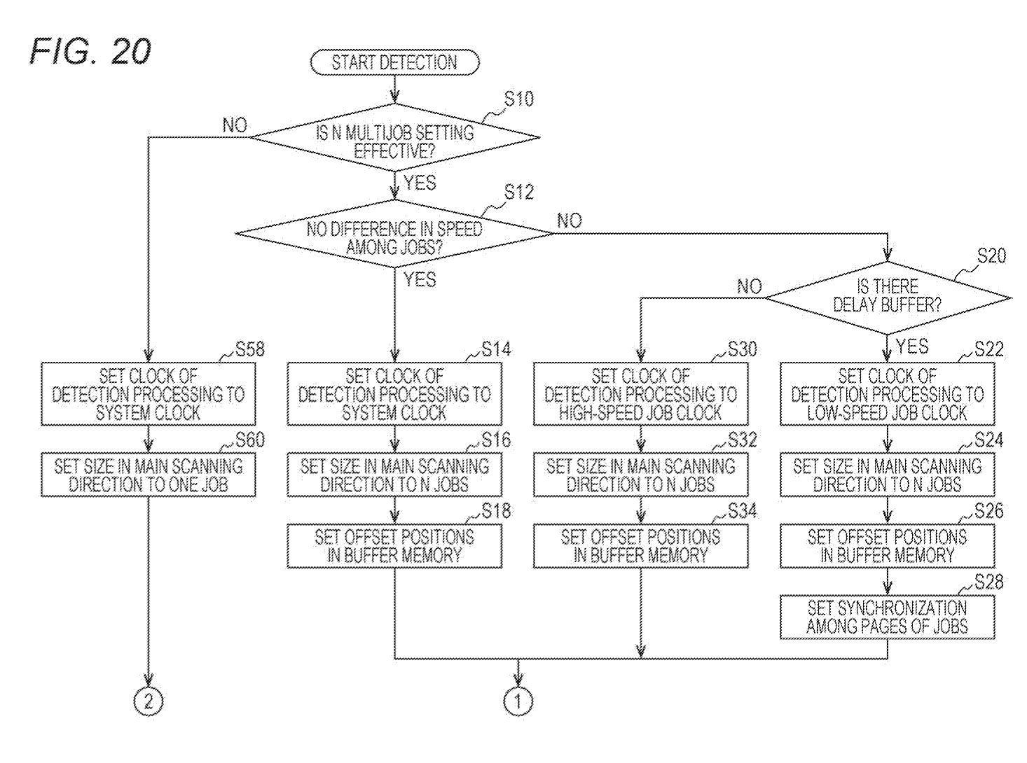

FIGS. 20 to 22 are flowcharts of processing executed by the CPU 20 to implement the detection processing 60 in the image processing apparatus 1. Processing in FIGS. 20 to 22 is implemented by, for example, the CPU 20 executing a given program.

In step S10, the CPU 20 determines whether N multijob setting is effective. The N multijob setting is to execute the detection processing at the same time for images of a plurality of jobs by arranging the images of a plurality of jobs in the main scanning direction in the buffer memory 23C, as described with reference to FIG. 5 and the like. In the image processing apparatus 1, the storage device 23 may store setting information as to whether making the N multijob setting effective. The CPU 20 implements determination of step S10 according to content of the setting information. When the N multijob setting is effective (YES in step S10), the CPU 20 advances the control to step S12, otherwise (NO in step S10), the CPU 20 advances the control to step S58.

In step S12, the CPU 20 determines whether there is a difference in speed (the frequencies of writing data to the image memory 23A) among a plurality of jobs to be executed in the image processing apparatus 1. The CPU 20 forms a job database for storing data of the jobs to be executed from now in the storage device 23, and implements control in step S12 by reference to the job database. When the CPU 20 determines that there is the difference in speed among the jobs (YES in step S12), the CPU 20 advances the control to step S14, otherwise (NO in step S12), the CPU 20 advances the control to step S20.

In step S20, the CPU 20 determines whether the delay buffer (FIGS. 16 to 19) is provided in the image processing apparatus 1. The delay buffer is provided in the image processing apparatus 1, as a part of the storage device 23, for example. When the CPU 20 determines that the delay buffer is provided (YES in step S20), the CPU 20 advances the control to step S22, otherwise (NO in step S20), the CPU 20 advances the control to step S30.

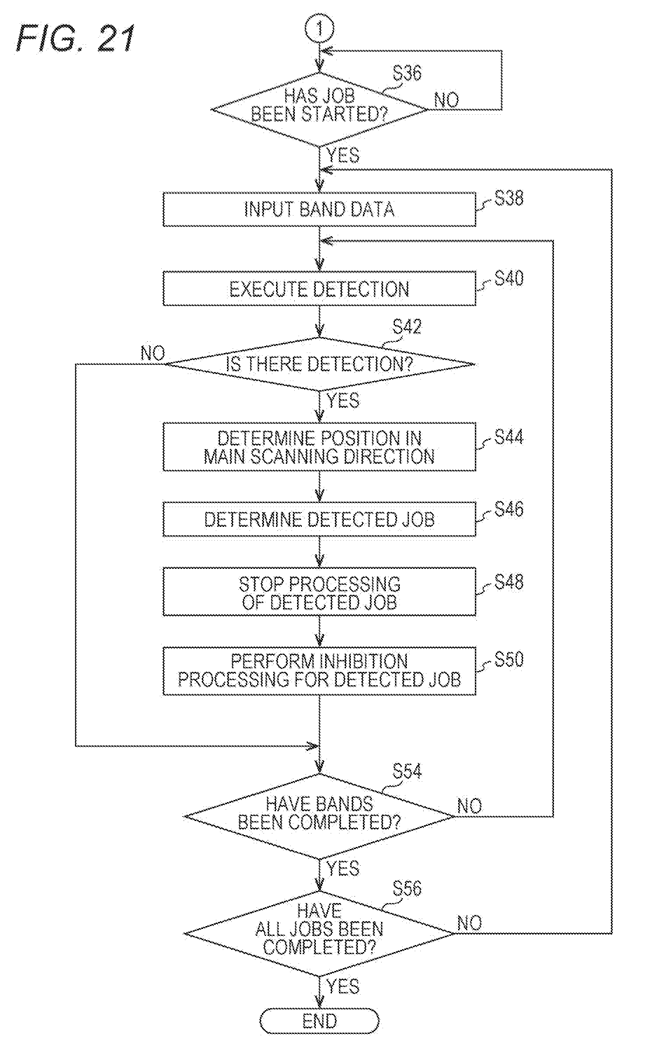

In step S22, the CPU 20 sets a clock of the detection processing to the lowest frequency in the frequencies of the plurality of jobs to be executed from now. In step S24, the CPU 20 sets the size of the buffer memory 23C in the main scanning direction to the size of N images. In step S26, the CPU 20 sets offset positions (points P0, P1, and P2 in FIG. 5) for arranging N images in the main scanning direction in the buffer memory 23C. In step S28, the CPU 20 sets synchronization of writing to the buffer memory 23C among pages of the plurality of jobs for which the detection processing is executed at the same time. Thereafter, the control proceeds to step S36 (FIG. 21).

In step S30, the CPU 20 sets the clock of the detection processing to the highest frequency in the frequencies of the plurality of jobs to be executed from now. In step S32, the CPU 20 sets the size of the buffer memory 23C in the main scanning direction to the size of N images. In step S34, the CPU 20 sets offset positions (points P0. P1, and P2 in FIG. 5) for arranging N images in the main scanning direction in the buffer memory 23C. Thereafter, the control proceeds to step S36 (FIG. 21).

In step S14, the CPU 20 sets the clock of the detection processing to a system clock (the frequency of writing to the image memory 23A of the job to be executed from now). In step S16, the CPU 20 sets the size of the buffer memory 23C in the main scanning direction to the size of N images. In step S18, the CPU 20 sets offset positions (points P0, P1, and P2 in FIG. 5) for arranging N images in the main scanning direction in the buffer memory 23C. Thereafter, the control proceeds to step S36 (FIG. 21).

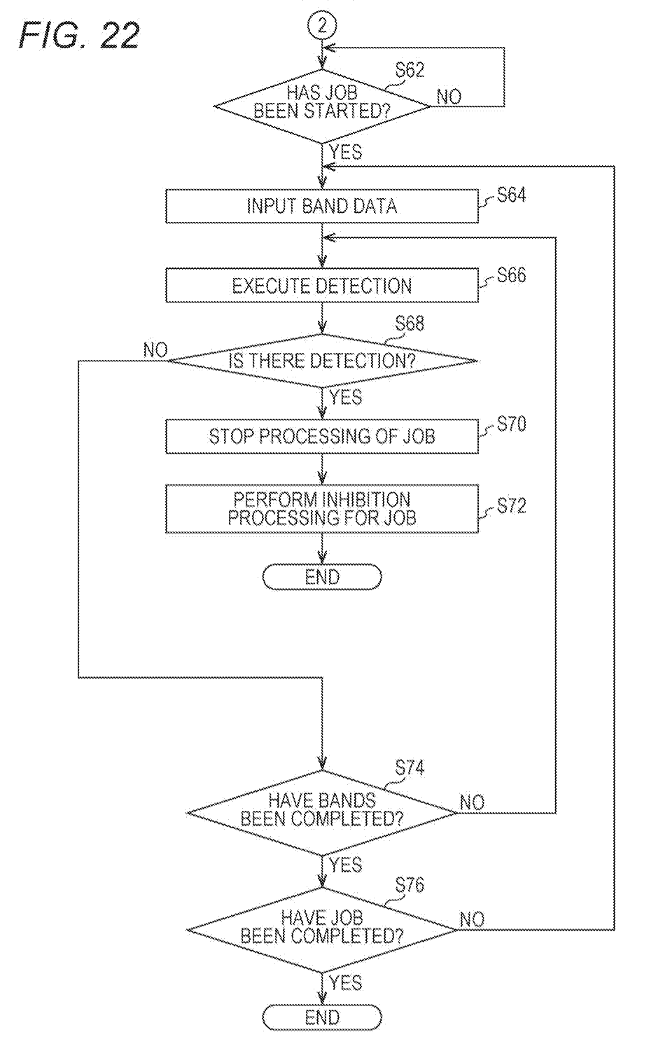

In step S58, the CPU 20 sets the clock of the detection processing to the system clock (the frequency of the job to be executed from now). In step S60, the CPU 20 sets the size of the buffer memory 23C in the main scanning direction to the size of one image (FIG. 8 and the like). Thereafter, the control proceeds to step S62 (FIG. 22).

In step S36, the CPU 20 determines whether writing of the image to the image memory 23A has been started by reference to FIG. 21. The CPU 20 holds the control in step S36 until the start of the writing is determined (NO in step S36), and the CPU 20 advances the control to step S38 when the start is determined (YES in step S36).

In step S38, the CPU 20 inputs (writes) data of one DET band of each of images of two or more jobs to the buffer memory 23C. In step S40, the CPU 20 executes the detection processing (detection determination processing 61) for the data (image) of one DET band in the buffer memory 23C.

In step S42, the CPU 20 determines whether the specific image pattern has been detected in the detection determination processing 61. When determining that the specific image pattern has been detected (YES in step S42), the CPU 20 advances the control to step S44. When determining that the specific image pattern has not been detected (NO in step S42), the CPU 20 advances the control to step S54.

In step S44, the CPU 20 determines the position in the main scanning direction in the buffer memory 23C, of the specific image pattern detected in the detection determination processing 61. In step S46, the CPU 20 determines an image (job) including the specific image pattern from among the plurality of jobs to be processed in the detection determination processing 61 at the same time, using the position determined in step S44 (job determination processing 62). In FIG. 21, the job including the specific image pattern is described as “detected job”.

In step S48, the CPU 20 stops the detection determination processing 61 for the job determined as the “detected job” in step S46. Note that the CPU 20 continues the detection determination processing 61 for the remaining jobs.

In step S50, the CPU 20 executes the inhibition processing 70 (FIG. 3) for the job determined as the “detected job” in step S46. In the inhibition processing 70, the CPU 20 may write dummy data to a portion where the specific image pattern has been detected.

In step S52, the CPU 20 determines whether the detection processing (detection determination processing 61) for all the RIP bands of all the jobs has been completed. When determining that the detection processing for all the RIP bands has not been completed yet (NO in step S52), the CPU 20 returns the control to step S40. When determining that the detection processing has been completed (YES in step S52), the CPU 20 advances the control to step S54.

In step S54, the CPU 20 determines whether the detection processing for the images of all the pages of all the jobs to be processed has been completed. When determining that the detection processing for the images of all the pages has not been completed yet (NO in step S54), the CPU 20 returns the control to step S38. When determining that the detection processing has been completed (YES in step S54), the CPU 20 terminates the processing illustrated in FIGS. 20 to 22.

In step S62, the CPU 20 determines whether writing of the image to the image memory 23A has been started by reference to FIG. 22. The CPU 20 holds the control in step S62 until the start of the writing is determined (NO in step S62), and the CPU 20 advances the control to step S64 when the start is determined (YES in step S62).

In step S64, the CPU 20 inputs (writes) RIP bands of respective images of two or more jobs to the buffer memory 23C. In step S66, the CPU 20 sequentially executes the detection processing (detection determination processing 61) for the image written in the buffer memory 23C for each RIP band.

In step S68, the CPU 20 determines whether the specific image pattern has been detected in the detection determination processing 61. When determining that the specific image pattern has been detected (YES in step S68), the CPU 20 advances the control to step S70. When determining that the specific image pattern has not been detected (NO in step S68), the CPU 20 advances the control to step S74.

In step S70, the CPU 20 stops the detection determination processing 61 of the job to be processed in the detection determination processing 61. In step S72, the CPU 20 executes the inhibition processing 70 (FIG. 3) for the job to be processed in the detection determination processing 61, and terminates the processing illustrated in FIGS. 20 to 22.

In step S72, the CPU 20 determines whether the detection processing (detection determination processing 61) for all the RIP bands of the images to be processed in the detection determination processing 61 has been completed. When determining that the detection processing for all the RIP bands has not been completed yet (NO in step S72), the CPU 20 returns the control to step S66. When determining that the detection processing has been completed (YES in step S72), the CPU 20 advances the control to step S76.

In step S76, the CPU 20 determines whether the detection processing for the images of all the pages of the job to be processed has been completed. When determining that the detection processing for the images of all the pages has not been completed yet (NO in step S76), the CPU 20 returns the control to step S64. When determining that the detection processing has been completed (YES in step S76), the CPU 20 terminates the processing in FIGS. 20 to 22.

In the above-described present embodiment, the upper limit number of the jobs to be processed in the detection processing 60 at the same time may be set according to system speed of the image processing apparatus 1, that is, speed at which the image processing apparatus 1 outputs an image. In the image processing apparatus 1, in a case of printing a color image, slower system speed than that in a case of printing a monochrome image may be set. In such an image processing apparatus 1, in the case of printing a color image, the number N of jobs to be processed in the detection processing 60 at the same time is set to be smaller than that in the case of printing a monochrome image. The “number N of jobs” at this time means the number of images arranged in the main scanning direction in the buffer memory 23C.

For example, in the case of printing a color image, the number of jobs is set to “2”, and in the case of printing a monochrome image, the number of jobs is set to “3”. Thereby, the CPU 20 arranges two images in the main scanning direction in the buffer memory 23C in the case of printing a color image, and arranges three images in the main scanning direction in the buffer memory 23C in the case of printing a monochrome image.

In the case where the upper limit number of the jobs is set as described above, and images of the number of jobs exceeding the upper limit number are written to the image memory 23A, the CPU 20 may write the images of the upper limit number of jobs to the buffer memory 23C, of the images of the jobs in the image memory 23A, and cause the detection processing for the images of the remaining jobs to stand by. When the detection processing for the image of the job being executed is completed, the CPU 20 executes the detection processing for the image of the waiting job.

Although embodiments of the present invention have been described and illustrated in detail, the disclosed embodiments are made for purposes of illustration and example only and not limitation. The scope of the present invention should be interpreted by terms of the appended claims, and it is intended that all modifications within the meaning and scope equivalent to the claims are included. In addition, the inventions described in the embodiments and modifications are intended to be implemented alone or in combination to the extent possible.

What is claimed is:

1. An image processing apparatus comprising:
a buffer memory; and
a hardware processor that outputs an image, and executes detection processing for searching for a predetermined image pattern in the image output by the hardware processor, wherein
the hardware processor
arranges images of a plurality of jobs in a first direction and writes the images in the buffer memory, and
advances the detection processing for the images of the plurality of jobs written in the buffer memory along a second direction intersecting with the first direction.

2. The image processing apparatus according to claim 1, wherein the hardware processor specifies a job of which the image pattern has been detected from among the plurality of jobs on the basis of a position at which the image pattern has been detected in the detection processing and positions of the respective images of the plurality of jobs in the first direction in the buffer memory.

3. The image processing apparatus according to claim 1, wherein the hardware processor writes the respective images of the plurality of jobs to the buffer memory at a same frequency.

4. The image processing apparatus according to claim 1, further comprising
an output device that outputs the image, wherein
the hardware processor
outputs, in the output device, an image of a job of which the image pattern has not been detected in the detection processing, and
does not output, in the output device, an image of a job of which the image pattern has been detected in the detection processing.

5. The image processing apparatus according to claim 4, wherein the hardware processor outputs a predetermined image in the output device instead of an image of a job of which the image pattern has been detected in the detection processing.

6. The image processing apparatus according to claim 1, wherein, in a case of processing the number of jobs, the number exceeding a predetermined upper limit, the hardware processor arranges images of the upper limit number of jobs in the first direction and writes the images to the buffer memory, and causes remaining jobs to stand by.

7. The image processing apparatus according to claim 4, wherein the number of the plurality of jobs for which the images are arranged in the first direction is set according to speed to output the image of the job by the output device.

8. The image processing apparatus according to claim 1, further comprising
an image memory, wherein
the hardware processor writes image data in a raster format of each of the plurality of jobs to the image memory,
the image to be written to the buffer memory is an image of the image data written in the image memory, and
the hardware processor executes detection processing for the image written in the buffer memory at a lowest frequency in frequencies for writing the image data of the plurality of jobs to the image memory.

9. The image processing apparatus according to claim 1, further comprising
an image memory, wherein
the hardware processor writes image data in a raster format of each of the plurality of jobs to the image memory,
the image to be written to the buffer memory is an image of the image data written in the image memory, and
the hardware processor executes detection processing for the image written in the buffer memory at a highest frequency in frequencies for writing the image data of the plurality of jobs to the image memory.

10. The image processing apparatus according to claim 1, wherein the plurality of jobs includes scanning a first surface of a document and scanning a second surface of the document.

11. The image processing apparatus according to claim 1, wherein the hardware processor outputs the image by at least one of printing the image to a recording sheet, displaying the image to a display, and copying data of the image to a recording medium attachable to and detachable from the image processing apparatus.

12. A non-transitory recording medium storing a computer readable program performed by a hardware processor of an image processing apparatus including a buffer memory,
the program causing the hardware processor to perform:
arranging images of a plurality of jobs in a first direction and writing the images to the buffer memory; and
advancing detection processing for searching for a predetermined image pattern for the images of the plurality of jobs written in the buffer memory along a second direction intersecting with the first direction.
